(19) United States
(12) Patent Application Publication
(10) Pub. No.: US 2007/0248288 A1
(43) Pub. Date: Oct. 25, 2007

(54) Image processing device, and recording medium

(75) Inventors: Takashi Nagao, Ashigarakami-gun (JP); Yukio Kumazawa, Ashigarakami-gun (JP); Junichi Kaneko, Kanagawa (JP); Yasuhiko Kaneko, Kanagawa (JP)

Correspondence Address: OLIFF & BERRIDGE, PLC, P.O. BOX 19928, ALEXANDRIA, VA, 22320, US

(73) Assignees: FUJI XEROX CO., LTD., TOKYO (JP); FUJIFILM CORPORATION, TOKYO (JP)

(21) Appl. No.: 11/707,066

(22) Filed: Feb. 16, 2007

(30) Foreign Application Priority Data
Apr. 20, 2006 (JP) 2006-116641

(51) Int. Cl. G06K 9/54

(52) U.S. Cl. 382/303

(57) ABSTRACT

The present invention provides an image processing device. The image processing device includes an image processing section constructed by individual modules being connected in a pipeline form or a directed acyclic graph form, such that a buffer module is connected at least one of a preceding stage and a following stage of individual image processing modules. In the image processing device, the individual image processing modules are realized by corresponding programs being executed in parallel by a program executing resource provided at the image processing device. The image processing device further has a priority level controlling component which carries out initial setting of execution priority levels of the programs of the individual image processing modules, and changing of the execution priority levels in accordance with extents of progress of image processing.

### BACKGROUND

1. Technical Field

The present invention relates to an image processing device, a recording medium, and a data signal, and in particular, to an image processing device having an image processing section constructed by image processing modules and buffer modules being connected in a pipeline form or a directed acyclic graph form, and to a recording medium at which an image processing program for making a computer function as the image processing device is recorded.

2. Related Art

In image processing devices which carry out image processing on inputted image data, and DTP (desktop publishing) systems which can handle images, and print systems which record images expressed by inputted image data onto recording materials, and the like, various types of image processing, such as enlargement/reduction, rotation, affine transformation, color conversion, filtering processing, image composing, and the like are carried out on inputted image data. In these devices and systems, if the attributes of the inputted image data and the contents, order, parameters, and the like of the image processing for the image data are fixed, there are cases in which the image processing are carried out by hardware which is designed exclusively therefor. However, for example, if various image data having different color spaces or different numbers of bits per pixel are inputted, or if the contents, the order, the parameters or the like of the image processing are changed variously, a structure which can more flexibly change the image processing to be executed is needed.

### SUMMARY OF THE INVENTION

According to an aspect of the invention, there is provided an image processing device including an image processing section constructed by individual modules being connected in a pipeline form or a directed acyclic graph form, such that a buffer module is connected at least one of a preceding stage and a following stage of individual image processing modules. Each of the plurality of image processing modules has functions of acquiring image data in units of a unit data amount from a preceding stage of its own module, and carrying out a predetermined image processing on acquired image data, and outputting image data which has undergone the predetermined image processing or processing results of the predetermined image processing to a following stage of its own module, and the plurality of image processing modules are selected from among plural types of image processing modules whose types or contents of executed image processing are respectively different. The buffer module has a buffer, and in a case in which an image processing module is connected at a preceding stage of its own module, the buffer module causes writing of image data, which is outputted from the image processing module of the preceding stage, to the buffer, and in a case in which an image processing module is connected at a following stage of its own module, the buffer module causes the image processing module of the following stage to read image data which is stored in the buffer. In the image processing device, the individual image processing modules are realized by corresponding programs being executed in parallel by a program executing resource provided at the image processing device. The image processing device further includes a priority level controlling component which carries out initial setting of execution priority levels of the programs of the individual image processing modules, and changing of the execution priority levels in accordance with extents of progress of image processing.

### BRIEF DESCRIPTION OF THE DRAWINGS

Exemplary embodiments of the present invention will be described in detail based on the following figures, wherein:

FIGS. 1A through 1C are a block diagram showing the schematic structure of a computer (image processing device) relating to exemplary embodiments of the present invention;

FIGS. 2A and 2B are sequence diagrams for explaining processing by applications;

FIG. 3A is a flowchart showing the contents of module generating processing which is executed by a module generating section;

FIG. 3B is a schematic diagram explaining a table of a workflow managing section;

FIGS. 4A through 4C are block diagrams showing structural examples of image processing sections;

FIGS. 5A and 5B are a flowchart showing the contents of buffer control processing which is executed by a buffer control section of a buffer module;

FIG. 6 is a flowchart showing the contents of request reception interruption processing which is executed by the buffer control section of the buffer module;

FIGS. 7A and 7B are a flowchart showing the contents of data writing processing which is executed by the buffer control section of the buffer module;

FIGS. 8A through 8C are schematic diagrams explaining processing in a case in which image data which is an object of interruption is spread over plural unit buffer regions for storage;

FIGS. 9A and 9B are a flowchart showing the contents of data reading processing which is executed by the buffer control section of the buffer module;

FIGS. 10A through 10C are schematic diagrams explaining processing in a case in which image data which is an object of reading is spread over plural unit buffer regions for storage;

FIGS. 11A and 11B are a flowchart showing the contents of image processing module initialization processing which is executed by a control section of an image processing module;

FIGS. 12A and 12B are a flowchart showing the contents of image processing module control processing which is executed by the control section of the image processing module;

FIG. 13A is a block diagram showing the schematic structure of the image processing module and processing which are executed;

FIG. 13B is a block diagram showing the schematic structure of the buffer module and processing which are executed;

FIGS. 14A through 14D are flowcharts showing the contents of block unit control processing which are executed by a processing managing section relating to a first exemplary embodiment of the present invention;

FIG. 15 is a schematic diagram explaining the flow of image processing at an image processing section;

FIGS. 16A through 16E are schematic diagrams showing, in the first exemplary embodiment of the present invention, examples of changes in execution priority levels of threads corresponding to individual image processing modules, which accompany the progress of a series of image processing at the image processing section;

FIGS. 17A and 17B are block diagrams for explaining the defining of positions of image processing modules in a connected form which is a pipeline form or a directed acyclic graph form;

FIGS. 18A through 18E are flowcharts showing the contents of block unit control processing which are executed at a processing managing section relating to a second exemplary embodiment of the present invention;

FIG. 19A to FIG. 19C are schematic diagrams showing examples of changes in execution priority levels of threads corresponding to individual image processing modules in the second exemplary embodiment of the present invention;

FIG. 20 is a flowchart showing the contents of block unit control processing which is executed by a processing managing section relating to a third exemplary embodiment of the present invention;

FIGS. 21A to 21C are a block diagram showing the schematic structure of a computer (image processing device) relating to a fourth exemplary embodiment of the present invention;

FIGS. 22A through 22D are flowcharts showing the contents of block unit control processing which are executed by a processing managing section relating to the fourth exemplary embodiment of the present invention;

FIGS. 23A through 23C are schematic diagrams showing, in the fourth exemplary embodiment of the present invention, examples of changes in execution priority levels of CPU threads and high-speed computing unit threads corresponding to individual image processing modules, which accompany the progress of a series of image processing at an image processing section;

FIG. 24 is a flowchart showing another example of the contents of block unit control processing;

FIG. 25 is a flowchart showing another example of the contents of block unit control processing; and

FIG. 26 is a schematic diagram explaining the flow of block unit processing in a form in which a buffer module directly requests an image processing module of a preceding stage for image data.

### DETAILED DESCRIPTION

Exemplary embodiments of the present invention will be described in detail hereinafter with reference to the drawings.

### First Exemplary Embodiment

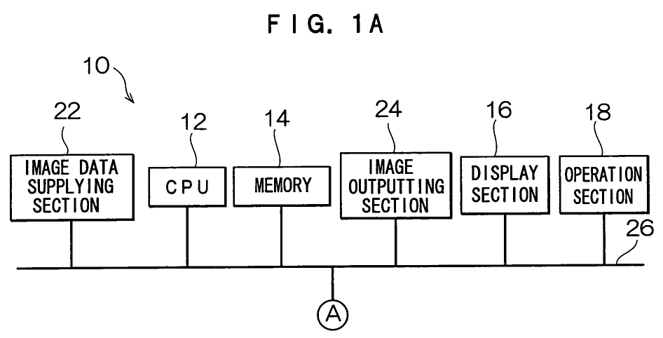

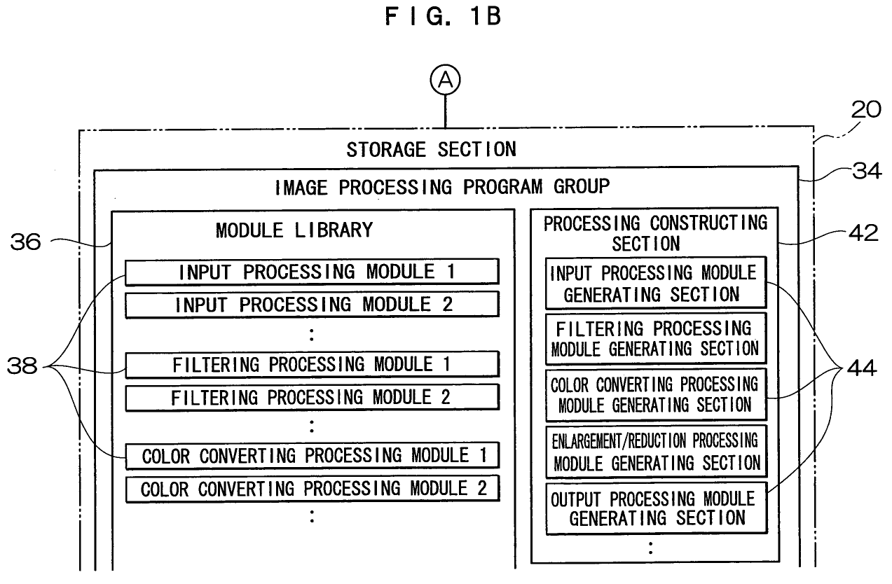

A computer 10, which can function as an image processing device relating to the present invention, is shown in FIGS. 1A through 1C. The computer 10 may be built-into an arbitrary image handling device which requires that image processing be carried out at the interior thereof, such as a copier, a printer, a fax machine, a multifunction device combining the functions thereof, a scanner, a photograph printer, or the like, or may be an independent computer such as a personal computer (PC) or the like, or may be a computer which is built-into a portable device such as a PDA (personal digital assistant), a cellular phone, or the like.

The computer 10 has a CPU 12, a memory 14, a display section 16, an operation section 18, a storage section 20, an image data supplying section 22, and an image outputting section 24, and they are connected to one another via a bus 26. When the computer 10 is built-into an image handling device such as described above, the display panel formed from an LCD or the like, and the ten key or the like, which are provided at the image handling device can be used as the display section 16 and the operation section 18. When the computer 10 is an independent computer, a display, and a keyboard, a mouse, or the like which are connected to the computer can be used as the display section 16 and the operation section 18. Further, an HDD (hard disk drive) is suitable for the storage section 20, or instead, another non-volatile storage component, such as a flash memory or the like, can be used.

It suffices for the image data supplying section 22 to be able to supply the image data which is the object of processing. For example, an image reading section which reads an image recorded on a recording material such as a paper or a photographic film or the like and outputs image data, or a receiving section which receives image data from the exterior via a communication line, or an image storage section (the memory 14 or the storage section 20) which stores image data, or the like can be used as the image data supplying section 22. It suffices for the image outputting section 24 to output image data which has been subjected to image processing, or an image which that image data expresses. For example, an image recording section which records an image which the image data expresses onto a recording material such as paper or a photosensitive material or the like, or a display section which displays the image which the image data expresses on a display or the like, or a writing device which writes the image data to a recording medium, or a transmitting section which transmits the image data via a communication line, can be used as the image outputting section 24. Further, the image outputting section 24 may be an image storage section (the memory 14 or the storage section 20) which simply stores the image data which has undergone the image processing.

As shown in FIGS. 1A through 1C, the storage section 20 stores, as various types of programs which are executed by the CPU 12, a program of an operating system 30 which governs the management of resources such as the memory 14 or the like, the management of the execution of programs by the CPU 12, the communication between the computer 10 and the exterior, and the like; an image processing program group 34 which makes the computer 10 function as the image processing device relating to the present invention; and programs (shown as “application program group 32” in FIGS. 1A through 1C) of various types of applications 32 which cause the image processing device, which is realized by the CPU 12 executing the aforementioned image processing program group, to carry out desired image processing.

The image processing program group 34 is programs which are developed so as to be able to be used in common at various types of image handling devices and various devices (platforms) such as portable devices, PCs, and the like, for the purpose of reducing the burden of development at the time of developing the aforementioned various types of image handling devices and portable devices, and reducing the burden of development at the time of developing image processing programs which can be used in PCs and the like. The image processing program group 34 corresponds to the image processing program relating to the present invention. The image processing device, which is realized by the image processing program group 34, constructs, in accordance with a construction instruction from the application 32, an image processing section which carries out the image processing(s) instructed by the application 32, and, in accordance with an execution instruction from the application 32, carries out image processing(s) by the image processing section (details will be described later). The image processing program group 34 provides the application 32 with an interface for instructing the construction of an image processing section which carries out desired image processing(s) (an image processing section of a desired structure), and for instructing execution of image processing(s) by the constructed image processing section. Therefore, even in a case such as when an arbitrary device, which must carry out image processing(s) at the interior, is newly developed or the like, with regard to the development of a program which carries out the image processing(s), it suffices to merely develop the application 32 which, by using the aforementioned interface, causes the image processing program group 34 to carry out the image processing(s) needed at that device. Because there is no longer the need to newly develop a program which actually carries out the image processing(s), the burden of development can be lessened.

As mentioned above, the image processing device which is realized by the image processing program group 34 constructs, in accordance with a construction instruction from the application 32, an image processing section which carries out the image processing(s) instructed by the application 32, and carries out the image processing(s) by the constructed image processing section. Therefore, even in a case in which, for example, the color space or the number of bits per pixel of the image data which is the object of image processing is unfixed, or the contents, the order, the parameters, or the like of the image processing(s) to be executed are unfixed, due to the application 32 instructing the re-construction of the image processing section, the image processing(s) executed by the image processing device (the image processing section) can be flexibly changed in accordance with the image data which is the object of processing, or the like.

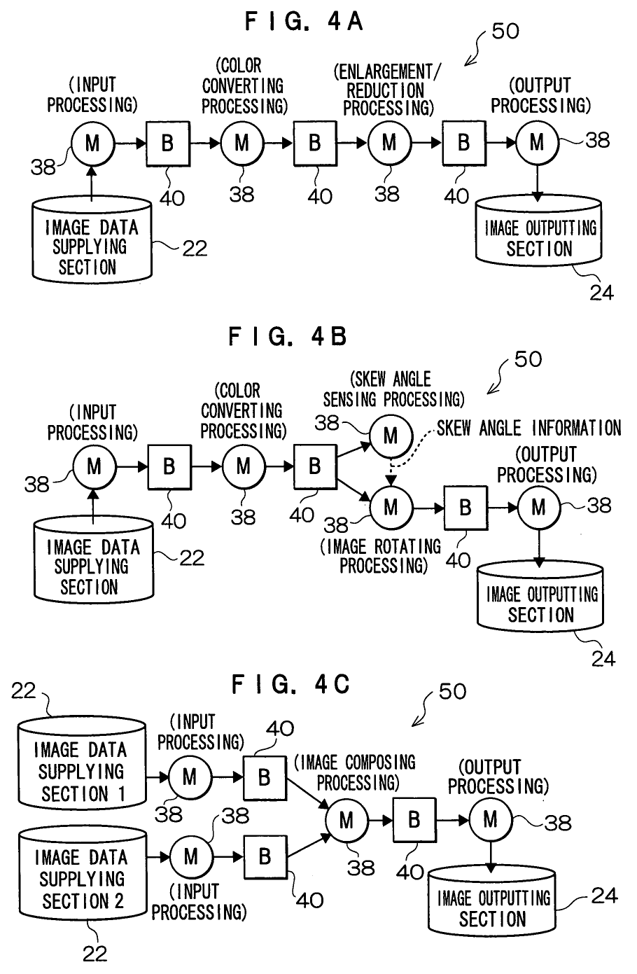

The image processing program group 34 will be described hereinafter. As shown in FIGS. 1A through 1C, the image processing program group 34 is broadly divided into a module library 36, programs of a processing constructing section 42, and programs of a processing managing section 46. Although details thereof will be described later, the processing constructing section 42 relating to the exemplary embodiments of the present invention constructs, in accordance with an instruction from the application and as shown in FIGS. 4A through 4C as examples, an image processing section 50 which is formed by one or more image processing modules 38 which carry out image processing which are set in advance, and buffer modules 40 which are disposed at least one of the preceding stage and the following stage of the individual image processing modules 38 and which have buffers for storing image data, being connected together in one of a pipeline form and a DAG (directed acyclic graph) form. Each image processing module itself structuring the image processing section 50 is a program which is executed by the CPU 12 and which is for causing a predetermined image processing to be carried out at the CPU 12. The programs of the plural types of the image processing modules 38, which carry out respectively different image processing which are set in advance (e.g., input processing, filtering processing, color converting processing, enlargement/reduction processing, skew angle sensing processing, image rotating processing, image composing processing, output processing, and the like), are respectively registered in the module library 36.

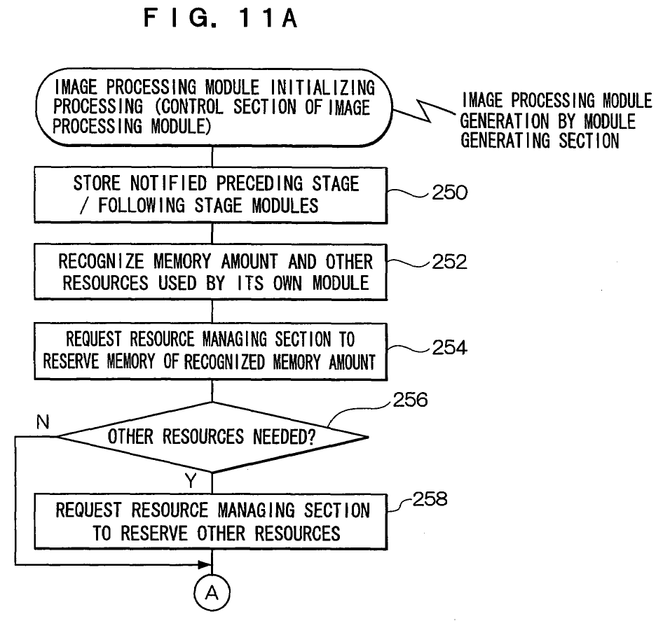

As shown in FIG. 13A as well as an example, each of the image processing modules 38 is structured from an image processing engine 38A and a control section 38B. The image processing engine 38A carries out the image processing on the image data, per a predetermined unit processing data amount. The control section 38B carries out input and output of image data with the modules at the preceding stage and the following stage of the image processing module 38, and controls the image processing engine 38A. The unit processing data amount at each of the image processing modules 38 is selected and set in advance in accordance with the type of the image processing which the image processing engine 38A carries out or the like, from among an arbitrary number of bytes such as one line of an image, plural lines of an image, one pixel of an image, one surface of an image, or the like. For example, at the image processing modules 38 which carry out color converting processing and filtering processing, the unit processing data amount is one pixel. At the image processing module 38 which carries out enlargement/reduction processing, the unit processing data amount is one line of an image or plural lines of an image. At the image processing module 38 which carries out image rotating processing, the unit processing data amount is one surface of an image. At the image processing module 38 which carries out image compression/decompression processing, the unit processing data amount is N bytes which depends on the execution environment.

The image processing modules 38, at which the types of the image processing which the image processing engines 38A execute are the same but the contents of the executed image processing are different, also are registered in the module library 36. (In FIGS. 1A through 1C, these types of image processing modules are designated as “module 1” and “module 2”.) For example, with regard to the image processing modules 38 which carry out enlargement/reduction processing, there are plural image processing modules 38 such as the image processing module 38 which carries out reduction processing which reduces inputted image data by 50% by thinning every other pixel, the image processing module 38 which carries out enlargement/reduction processing at an enlargement/reduction rate which is designated for inputted image data, and the like. Further, for example, with regard to the image processing modules 38 which carry out color converting processing, there are the image processing module 38 which converts an RGB color space into a CMY color space, the image processing module 38 which converts the opposite way, and the image processing module 38 which carries out conversion from an L*a*b* color space or the like to another color space or conversion from another color space to the L*a*b* color space or the like.

In order to input the image data needed for the image processing engine 38A to carry out processing in units of the unit processing data amount, the control section 38B of the image processing module 38 acquires image data in units of a unit read data amount from the module (e.g., the buffer module 40) of the preceding stage of its own module, and carries out the processing of outputting the image data outputted from the image processing engine 38A, to the module of the following stage (e.g., the buffer module 40) in units of unit writing data. (If image processing involving an increase or decrease in the data amount such as compression or the like is not carried out at the image processing engine 38A, the unit write data amount equals the unit processing data amount). Or, the control section 38B carries out the processing of outputting the results of image processing by the image processing engine 38A to the exterior of its own module (e.g., if the image processing engine 38A carries out image analyzing processing such as skew angle sensing processing or the like, the results of the image analyzing processing, such as the results of sensing the skew angle or the like, may be outputted instead of the image data). The image processing modules 38, at which the types and contents of the image processing which the image processing engines 38A execute are the same but the aforementioned unit processing data amount or unit read data amount or unit write data amount are different, also are registered in the module library 36. For example, although it was previously mentioned that the unit processing data amount at the image processing module 38 which carries out image rotating processing is one surface of an image, the image processing module 38, which carries out the same image rotating processing but whose unit processing data amount is one line of an image or plural lines of an image, may be included in the module library 36.

The program of each of the image processing modules 38 which are registered in the module library 36 is structured from a program which corresponds to the image processing engine 38A and a program which corresponds to the control section 38B. The program which corresponds to the control section 38B is made into a part. The program corresponding to the control section 38B is used in common for the image processing modules 38 whose unit read data amounts and unit write data amounts are the same among the individual image processing modules 38, regardless of the types and contents of the image processing executed at the image processing engines 38A (the same program is used as the program corresponding to the control sections 38B). In this way, the burden of development in developing the programs of the image processing modules 38 is reduced.

Note that, among the image processing modules 38, there are modules in which, in the state in which the attributes of the inputted image are unknown, the unit read data amount and the unit write data amount are not fixed, and the attributes of the input image data are acquired, and the unit read data amount and the unit write data amount are fixed by carrying out computation by substituting the acquired attributes into predetermined computation formulas. With respect to this type of image processing module 38, it suffices for the program corresponding to the control section 38B to be used in common at the image processing modules 38 at which the unit read data amount and the unit write data amount are derived by using the same computation formula. Further, the image processing program group 34 relating to the exemplary embodiments of the present invention can be installed in various types of devices as described above. Among the image processing program group 34, the numbers and types and the like of the image processing modules 38 which are registered in the module library 36 may of course be appropriately added, deleted, substituted, and the like, in accordance with the image processing which are required at the device in which the image processing program group 34 is installed.

As shown as an example in FIG. 13B as well, each of the buffer modules 40 structuring the image processing section 50 is structured from a buffer 40A and a buffer control section 40B. The buffer 40A is structured by a memory region which is reserved through the operating system 30 from the memory 14 provided at the computer 10. The buffer control section 40B carries out input and output of image data with the modules at the preceding stage and the following stage of the buffer module 40, and management of the buffer 40A. The buffer control section 40B itself of each buffer module 40 also is a program which is executed by the CPU 12, and the program of the buffer control section 40B also is registered in the module library 36. (The program of the buffer control section 40B is designated as “buffer module” in FIGS. 1A through 1C.)

The processing constructing section 42, which constructs the image processing section 50 in accordance with an instruction from the application 32, is structured from plural types of module generating sections 44 as shown in FIGS. 1A through 1C. The plural types of module generating sections 44 correspond to image processing which differ from one another, and, by being started-up by the application 32, carry out the processing of generating module groups from the image processing modules 38 and the buffer modules 40 which are for realizing the corresponding image processing. Note that FIGS. 1A through 1C illustrate, as examples of the module generating sections 44, the module generating sections 44 which correspond to the types of image processing which are executed by the individual image processing modules 38 registered the module library 36. However, the image processing corresponding to the individual module generating sections 44 may be image processing which are realized by plural types of the image processing modules 38 (e.g., skew correcting processing which is formed from skew angle sensing processing and image rotating processing). In a case in which the needed image processing is a processing which combines plural types of image processing, the application 32 successively starts-up the module generating section 44 corresponding to any of the plural types of image processing. In this way, the image processing section 50, which carries out the image processing which are needed, is constructed by the module generating sections 44 which are successively started-up by the application 32.

As shown in FIGS. 1A through 1C, the processing managing section 46 is structured so as to include a workflow managing section 46A which controls the execution of the image processing at the image processing section 50, a resource managing section 46B which manages the use of the memory 14 and the resources of the computer 10 such as various files and the like by the respective modules of the image processing section 50, and an error managing section 46C which manages errors which arise at the image processing section 50. Note that, in the exemplary embodiments of the present invention, in the image processing section 50 which is constructed by the processing constructing section 42, the individual image processing modules 38 structuring the image processing section 50 operate so as to carry out image processing in parallel while transferring image data to the following stages in units of a data amount which is smaller than one surface of an image (which is called block unit processing).

For example, any of the following three managing methods can be employed as the method of managing memory by the resource managing section 46B: a first managing method which, each time there is a request from an individual module of the image processing section 50, reserves, from the memory 14 and through the operating system 30, a memory region to be allotted to the module which is the source of the request; a second managing method which reserves a memory region of a given size in advance (e.g., at the time when the power source of the computer 10 is turned on) from the memory 14 and through the operating system 30, and when there is a request from an individual module, allots a partial region of the memory region which is reserved in advance, to the module which is the source of the request; and a third managing method which reserves a memory region of a given size in advance from the memory 14 and through the operating system 30, and when there is a request from an individual module, if the size of the requested memory region is less than a threshold value, allots a partial region of the memory region which is reserved in advance to the module which is the source of the request, and if the size of the requested memory region is greater than or equal to the threshold value, reserves, through the operating system 30, a memory region to be allotted to the module which is the source of the request. Further, a structure may be employed in which it is possible to select and set by which of these managing methods the memory management is to be carried out.

Further, when an error arises while the image processing section 50 is in the midst of executing the image processing, the error managing section 46C acquires error information, such as the type of, the place of occurrence of, and the like of the error which has arisen, and acquires, from the storage section 20 or the like, device environment information which expresses the type and the structure and the like of the device in which is incorporated the computer 10 in which the image processing program group 34 is installed. The error managing section 46C determines the error notification method which corresponds to the device environment expressed by the acquired device environment information, and carries out processing for giving notice, through the determined error notification method, that an error has occurred.

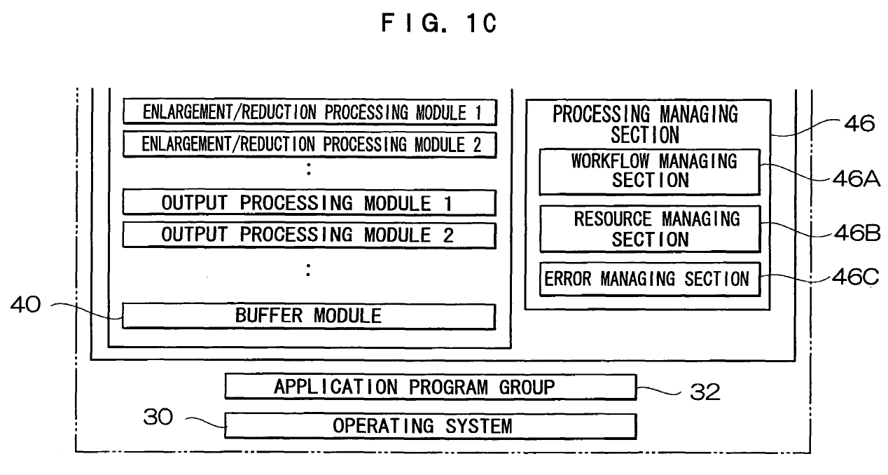

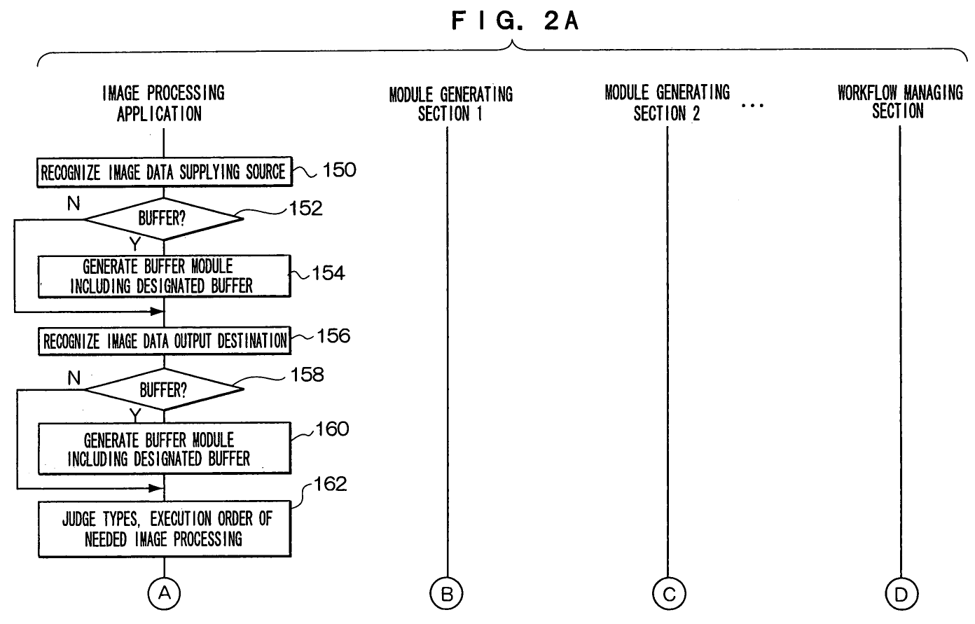

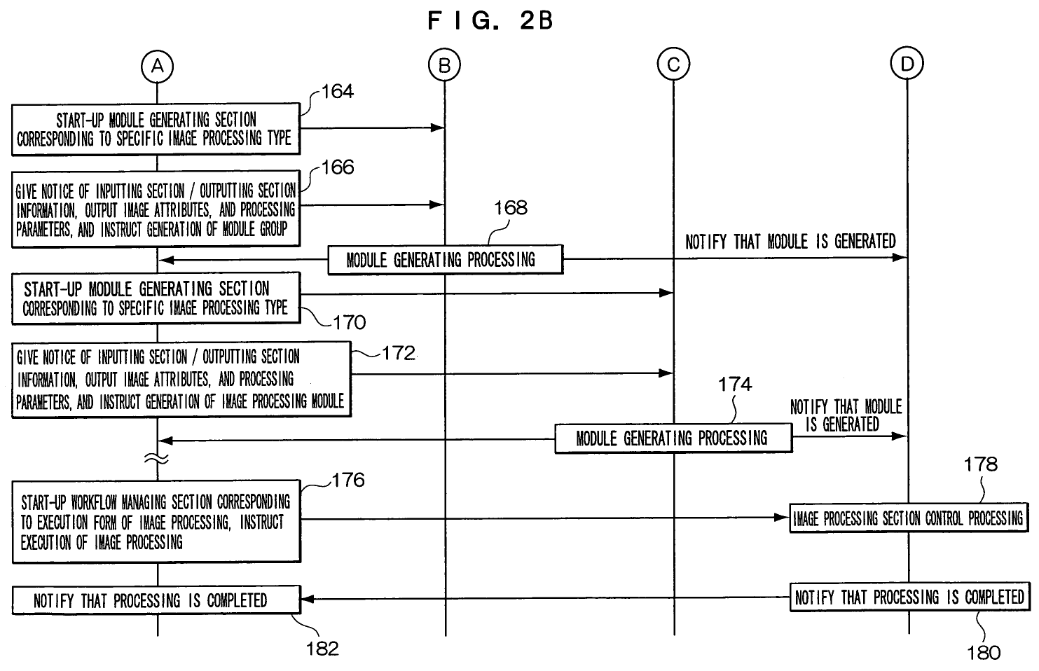

Operation of the first exemplary embodiment will be described next. In the device in which the image processing program group 34 is installed, when a situation arises in which it is necessary to carry out some type of image processing, this situation is detected by a specific application 32, and the processing shown in FIGS. 2A and 2B are carried out by that application 32. Examples of the situation in which it is necessary to carry out image processing are: a case in which an image is read by an image reading section serving as the image data supplying section 22, and the user instructs execution of a job which records the image as an image onto a recording material by an image recording section serving as the image outputting section 24, or displays the image as an image on a display section serving as the image outputting section 24, or writes the image data onto a recording medium by a writing device serving as the image outputting section 24, or transmits the image data by a transmitting section serving as the image outputting section 24, or stores the image data in an image storage section serving as the image outputting section 24, and a case in which the user instructs execution of a job which carries out one of the aforementioned recording onto a recording material, display on a display section, writing to a recording medium, transmission, and storage to an image storage section, on image data which is received by a receiving section serving as the image data supplying section 22 or is stored in an image storage section serving as the image data supplying section 22. Further, the situation in which it is necessary to carry out image processing is not limited to those described above, and may be, for example, a case in which, in a state in which the names or the like of processing which the applications 32 can execute are displayed in a list on the display section 16 in accordance with an instruction from the user, the processing which is the object of execution is selected by the user, or the like.

When it is sensed that a situation has arisen in which some type of image processing must be carried out as described above, the application 32 first recognizes the type of the image data supplying section 22 which supplies the image data which is the object of image processing (refer to step 150 of FIGS. 2A and 2B as well). In a case in which the recognized type is a buffer region (a partial region of the memory 14) (i.e., in a case in which the judgment of step 152 in FIGS. 2A and 2B is affirmative), the buffer module 40, which includes the buffer region designated as the image data supplying section 22, is generated (refer to step 154 of FIGS. 2A and 2B as well). The new generation of a buffer module 40, which will be described later, is carried out by the buffer control section 40B being generated by generating a thread (or a process or an object) which executes the program of the buffer control section 40B of the buffer module 40, and a memory region, which is used as the buffer 40A, being reserved by the generated buffer control section 40B. The generation of the buffer module 40 in this step 154 is achieved by setting parameters which make (the buffer control section 40B) recognize the designated buffer region as the buffer 40A which has already been reserved, and carrying out processing of generating the buffer control section 40B. The buffer module 40 generated here functions as the image data supplying section 22.

Next, in the same way as described above, the application 32 recognizes the type of the image outputting section 24 which serves as the output destination of the image data on which the image processing is carried out (refer to step 156 of FIGS. 2A and 2B as well). If the recognized type is a buffer region (a partial region of the memory 14) (i.e., if the judgment in step 158 of FIGS. 2A and 2B is affirmative), the buffer module 40, which includes the buffer region designated as the image outputting section 24, is generated in the same way as described above (refer to step 160 of FIGS. 2A and 2B as well). The buffer module 40 which is generated here functions as the image outputting section 24. Further, the application 32 recognizes the contents of the image processing to be executed, and divides the image processing to be executed into a combination of image processing of levels corresponding to the individual module generating sections 44, and judges the types of the image processing necessary in order to realize the image processing which is to be executed, and the order of execution of the individual image processing (refer to step 162 of FIGS. 2A and 2B as well). Note that this judgment can be realized by, for example, the aforementioned types of image processing and orders of execution of individual image processing being registered in advance as information in correspondence with the types of jobs whose execution can be instructed by the user, and the application 32 reading-out the information corresponding to the type of job for which execution has been instructed.

Then, on the basis of the types of image processing and order of execution which were judged in the above, the application 32 first starts-up the module generating section 44 which corresponds to the image processing which is first in the order of execution (i.e., generates a thread (or a process or an object) which executes the program of the module generating section 44). Thereafter (refer to step 164 of FIGS. 2A and 2B as well), the application 32 notifies the started-up module generating section 44 of, as information needed for generating a module group by that module generating section 44, input module identification information for identifying the input module which inputs image data to the module group, output module identification information for identifying the output module to which the module group outputs image data, input image attribute information expressing the attributes of the input image data which is inputted to the module group, and parameters of the image processing which is to be executed, and instructs generation of the corresponding module group (refer to step 166 of FIGS. 2A and 2B as well).

Note that, for the module group which is first in the order of execution, the image data supplying section 22 is the aforementioned input module. For the module groups which are second or thereafter in the order of execution, the final module (usually the buffer module 40) of the module group of the preceding stage is the input module. Further, at the module group which is last in the order of execution, the image outputting section 24 is the aforementioned output module, and therefore, the image outputting section 24 is designated as the output module. At the other module groups, the output module is not fixed. Therefore, designation by the application 32 is not carried out, and, in a case in which it is needed, the output module is generated and set by the module generating section 44. Further, the input image attributes and the parameters of the image processing may, for example, be registered in advance as information in correspondence with the types of jobs for which execution can be instructed by the user, and the application 32 can recognize them by reading-out the information corresponding to the type of the job for which execution is instructed. Or, the input image attributes and the parameters of the image processing may be designated by the user.

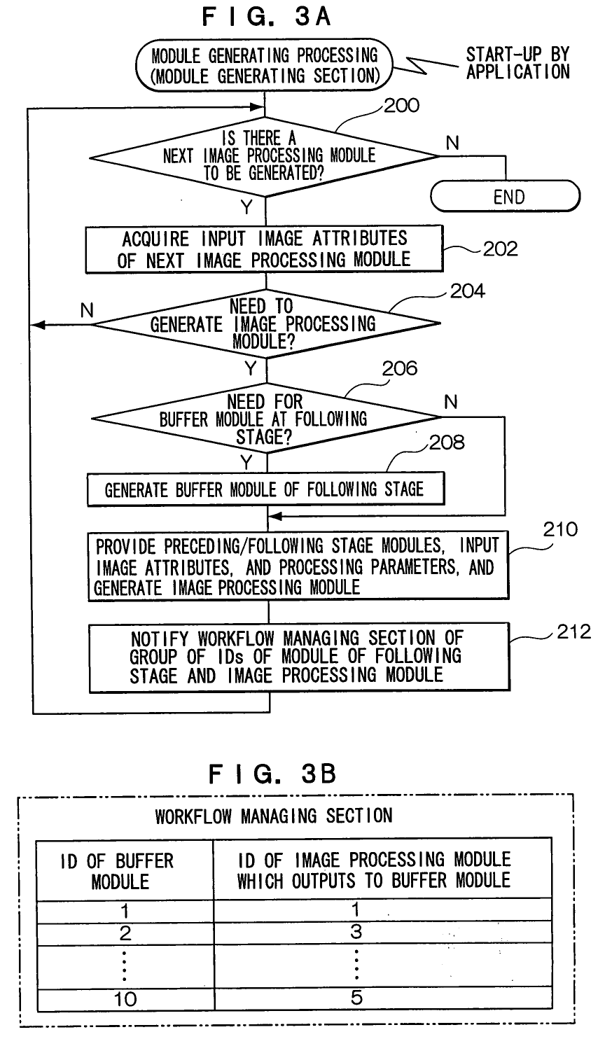

On the other hand, when the module generating section 44 is started-up by the application 32, the module generating section 44 carries out the module generating processing shown in FIG. 3A (refer to step 168 in FIGS. 2A and 2B as well). In the module generating processing, first, in step 200, at the module generating section 44, it is judged whether or not there is an image processing module 38 to be generated next. If the judgment is negative, the module generating processing ends. If there is an image processing module 38 to be generated, in step 202, the module generating section 44 acquires input image attribute information which expresses the attributes of the input image data to be inputted to the image processing module 38 which is to be generated. In next step 204, the module generating section 44 judges whether or not, also in view of the attributes of the input image data expressed by the information acquired in step 202, it is necessary to generate the image processing module 38 which was judged in previous step 200 as to be generated.

Specifically, for example, the module generating section 44, which corresponds to the module generating processing which is being executed, is a module generating section which generates a module group which carries out color converting processing, and the CMY color space is designated from the application 32 as the color space of the output image data by the parameters of the image processing. In this case, if it is ascertained, on the basis of the input image attribute information acquired in step 202, that the input image data is RGB color space data, there is the need to generate the image processing module 38 which carries out RGB→CMY color space conversion as the image processing module 38 which carries out the color space processing. However, if the input image data is data of the CMY color space, the attributes of the input image data and the attributes of the output image data match with respect to the color space, and therefore, it can be judged that there is no need to generate the image processing module 38 which carries out color space converting processing. If it is judged to be unnecessary, the routine returns to step 200.

Note that, in a case in which the buffer module 40 exists at the preceding stage of the image processing module 38 which is generated, the processing of acquiring the attributes of the input image data can be realized by acquiring the attributes of output image data from the image processing module 38 of an even further preceding stage which writes image data to that buffer module 40.

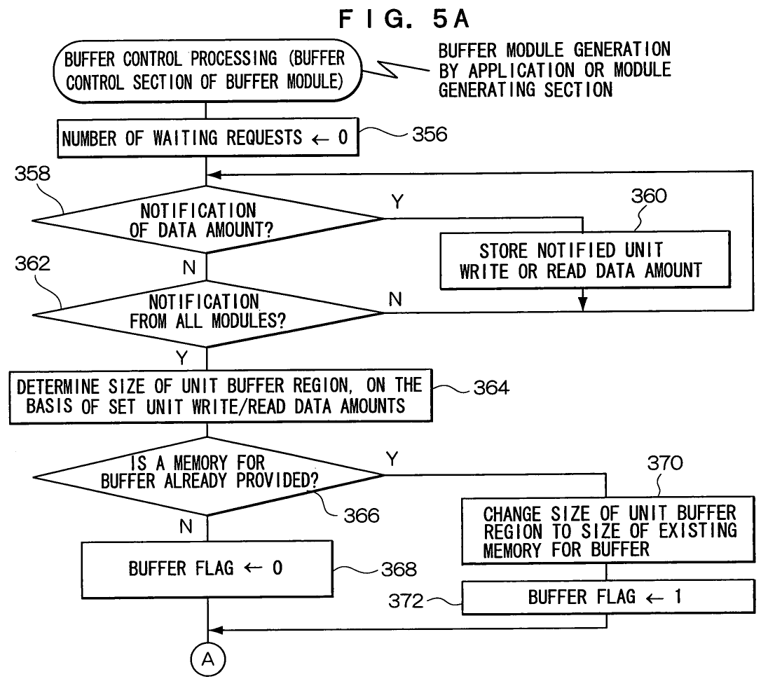

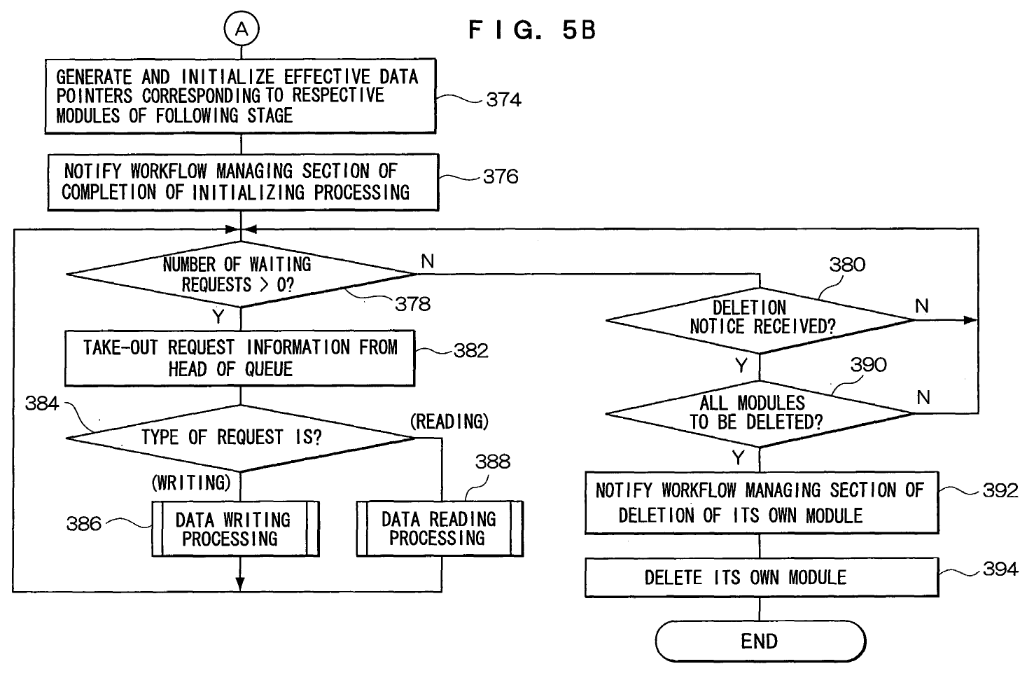

In next step 206, it is judged whether or not the buffer module 40 is needed at the following stage of the image processing module 38 which is generated. This judgment is negative in a case in which the following stage of the image processing module is an output module (the image outputting section 24) (e.g., refer to the image processing module 38 of the final stage in the image processing sections 50 shown in FIGS. 4A through 4C), or in a case in which the image processing module is a module which carries out image processing such as analysis or the like on the image data and outputs the results thereof to another image processing module 38, e.g., the image processing module 38 which carries out skew angle sensing processing in the image processing section 50 shown in FIG. 4B, and the routine moves on to step 210 without generating the buffer module 40. In cases other than those described above, the judgment is affirmative, and the routine moves on to step 208 where, by starting-up the buffer control section 40B (i.e., generating a thread (or a process or an object) which executes the program of the buffer control section 40B), the buffer module 40 which is connected at the following stage of the image processing module is generated. When the buffer control section 40B is started-up by the module generating section 44 (or the aforementioned application 32), the buffer control processing shown in FIGS. 5A and 5B is carried out. This buffer control processing will be described later.

In next step 210, the information of the module of the preceding stage (e.g., the buffer module 40) and the information of the buffer module 40 of the following stage, and the processing parameters and the attributes of the input image data inputted to the image processing module 38, are provided, and the image processing module 38 is generated. Note that information of the buffer module 40 of the following stage is not provided for the image processing module 38 for which it is judged in step 206 that the buffer module 40 of the following stage is not needed. Further, processing parameters are not provided in a case in which the processing contents are fixed and special image processing parameters are not required, such as in reduction processing of 50% for example.

In the module generating processing (step 210), the image processing module 38, which matches the attributes of the input image data acquired in step 202 and the processing parameters which are to be executed at the image processing module 38, is selected from among plural candidate modules which are registered in the module library 36 and which can be used as the image processing modules 38. For example, in a case in which the module generating section 44 which corresponds to the module generating processing which is being executed is a module generating section which generates a module group carrying out color converting processing, and the CMY color space is designated from the application 32 as the color space of the output image data by the processing parameters, and the input image data is data of the RGB color space, the image processing module 38 which carries out RGB→CMY color space conversion is selected from among the plural types of image processing modules 38 which are registered in the module library 36 and which carry out various types of color space processing.

Further, if the image processing module is the image processing module 38 which carries out enlargement/reduction processing and the designated enlargement/reduction rate is other than 50%, the image processing module 38, which carries out enlargement/reduction processing at an enlargement/reduction rate which is designated for the inputted image data, is selected. If the designated enlargement/reduction rate is 50%, the image processing module 38, which carries out enlargement/reduction processing specialized at an enlargement/reduction rate of 50%, i.e., which carries out reduction processing which reduces the inputted image data by 50% by thinning every other pixel, is selected. Note that the selection of the image processing module 38 is not limited to the above. For example, plural image processing modules 38, whose unit processing data amounts in the image processing by the image processing engines 38A are different, may be registered in the module library 36, and the image processing module 38 of the appropriate unit processing data amount may be selected in accordance with the operational environment, such as the size of the memory region which can be allotted to the image processing section 50 or the like (e.g., the smaller the aforementioned size, the image processing module 38 of an increasingly smaller unit processing data amount is selected, or the like). Or, the image processing module 38 may be selected by the application 32 or the user.

In next step 212, the workflow managing section 46A is notified of a group which is the ID of the buffer module 40 of the following stage and the ID of the generated image processing module 38. It suffices for these IDs to be information which can uniquely distinguish these individual modules. For example, the ID may be a number which is applied in the order of generating the individual modules, or may be the address on the memory of the object of the buffer module 40 or the image processing module 38, or the like. The information which is notified to the workflow managing section 46A is held within the workflow managing section 46A, for example, in the form of a table as shown in FIG. 3B, or in the form of a list, or in the form of an associative array or the like, and is used in later processing. Explanation will continue hereinafter with the information being held in the form of a table.

Note that, in the case of an image processing module 38 which does not have the buffer module 40 at the following stage as described previously, processing is carried out in accordance with the following method for example. In a case in which the image processing module 38 which is generated is one of the final point of a pipeline or the final point of a directed acyclic graph such as the image processing module 38 which carries out the output processing in FIG. 4A, that image processing module 38 is returned, as the output of the module generating section 44, to the application 32 which is the call-up source. Further, in a case, such as the image processing module 38 which carries out skew angle sensing processing in FIG. 4B, in which the results of the image processing at the generated image processing module 38 are used at another image processing module (the image processing module 38 which carries out image rotating processing in FIG. 4B), the module generating section 44 instructs repeated execution of processing until the processing with respect to that image processing module 38 are completed, and acquires the results of processing.

When the processing of step 212 ends, the module generating section 44 returns the control to step 200, and judges whether or not there is an image processing module to be generated next. Note that the individual module generating sections 44 generate module groups which carry out corresponding, given image processing. Therefore, this judgment can be realized by registering in advance and reading-out information relating to what kind of image processing modules are to be generated in what kind of connected relationship for each of the individual module generating sections 44, or by describing this in a program which operates the module generating sections 44. For example, in a case in which the module generating section 44, which corresponds to the module generating processing which is being executed, generates a module group which carries out image processing which are realized by plural types of image processing modules 38 (e.g., skew correction processing which is realized by the image processing module 38 which carries out skew angle sensing processing and the image processing module 38 which carries out image rotating processing), a module group containing two or more image processing modules 38 is generated.

When the application 32 is notified of the completion of generation of the module group as described above from the module generating section 44 which was instructed to generate the module group, the application 32 judges, on the basis of the results of the judgment in step 162 of FIGS. 2A and 2B, whether or not, in order to realize the image processing which are required, there is the need to also generate module groups which carry out other image processing. If the image processing which are required are processing which combine plural types of image processing, the application 32 starts-up the other module generating sections 44 corresponding to the individual image processing, and successively carries out the processing of giving notice of the information needed for module group generation (refer to steps 170 and 172 of FIGS. 2A and 2B as well). Then, due to the above-described module generating processing (FIG. 3A) being successively carried out (refer to step 174 in FIGS. 2A and 2B as well) by the module generating sections 44 which are successively started-up, the image processing section 50 which carries out the required image processing is constructed as shown as examples in FIGS. 4A through 4C.

Note that, in the exemplary embodiments of the present invention, in cases such as when the frequency of execution of a specific image processing is high, or the like, even after the image processing section 50 which carries out the specific image processing is generated, the application 32 does not instruct the plural types of module generating sections 44, which are for generating the image processing section 50 which carries out the specific image processing, to end processing, and retains them as threads (or processes or objects). Each time the need to carry out the specific image processing arises, by successively instructing the module generating sections 44, which remain as threads (or processes or objects), to generate module groups, the image processing section 50 which carries out the specific image processing can be re-generated. In this way, each time the need arises to carry out the specific image processing, there is no need for processing for respectively starting-up the corresponding module generating sections 44, and the time required to re-generate the image processing section 50 which carries out the specific image processing can be shortened.

When started-up by the module generating section 44, the control section 38B of the image processing module 38 carries out the image processing module initializing processing shown in FIGS. 11A and 11B. In this image processing module initializing processing, first, in step 250, due to the module generating section 44 carrying out the processing of step 210 of the module generating processing (FIG. 3A), the control section 38B stores the information of the modules of the preceding stage and the following stage of its own module which is provided from the module generating section 44. Further, in next step 252, on the basis of the type and the contents and the like of the image processing which the image processing engine 38A of its own module carries out, the control section 38B recognizes the size of the memory that its own module uses and other resources that its own module uses. Note that the memory which its own module uses is mainly the memory needed in order for the image processing engine 38A to carry out image processing. However, in a case in which the module of the preceding stage is the image data supplying section 22 or in a case in which the module of the following stage is the image outputting section 24, a memory for a buffer, which is for temporarily storing image data at times of transmitting and receiving image data to and from the modules of the preceding stage and the following stage, may be needed. Further, in a case in which information of a table or the like is included in the processing parameters, a memory region for holding this may be needed. Then, in step 254, the control section 38B informs the resource managing section 46B of the size which was recognized in step 252, and requests the resource managing section 46B to reserve a memory region of the notified size, and receives, from the resource managing section 46B, the memory region which is reserved by the resource managing section 46B.

In the image processing module initializing processing shown in FIGS. 11A and 11B (the control section 38B of the image processing module 38), when the needed memory region is reserved via the resource managing section 46B through the above-described processing, in next step 256, it is judged, on the basis of the processing results of previous step 252, whether or not (the image processing engine 38A of) its own module needs resources other than the memory. If the judgment is negative, the routine moves on to step 262 without any processing being carried out. If the judgment is affirmative, the routine moves on to step 258 where the resource managing section 46B is notified of the type and the like of the resources other than the memory which its own module needs, and is requested to reserve the notified other resources, and reserves them.

Next, in step 262, the control section 38B judges the module which is the preceding stage of its own module, and if no module exists at the preceding stage of its own module, the routine moves on to step 272. If the module of the preceding stage is other than the buffer module 40, e.g., is the image data supplying section 22 or a specific file or the like, initializing processing thereof is carried out in step 270 as needed, and the routine proceeds to step 272. Further, in a case in which a module exists at the preceding stage of its own module and that module of the preceding stage is the buffer module 40, the routine proceeds from step 262 to step 264, and the data amount of the image data acquired by reading-out image data one time from the buffer module 40 of the preceding stage (i.e., the unit read data amount) is recognized. If the number of buffer modules 40 of the preceding stage of its own module is one, there is one unit read data amount. However, in a case such as when there are plural buffer modules 40 of the preceding stage and the image processing engine 38A carries out image processing by using image data which is acquired from each of the plural buffer modules 40, such as in the case of the image processing module 38 which carries out image composing processing in the image processing section 50 shown in FIG. 4C for example, the unit read data amount corresponding to each buffer module 40 of the preceding stage is determined in accordance with the type and the contents of the image processing which the image processing engine 38A of its own module carries out, and the number of the buffer modules 40 of the preceding stage, and the like.

In step 266, by notifying a single one of the buffer modules 40 of the preceding stage of the unit read data amount which was recognized in step 264, the unit read data amount for that buffer module 40 is set (refer to (1) of FIG. 13A as well). In next step 268, it is judged whether or not unit read data amounts are set at all of the buffer modules 40 of the preceding stage of its own module. If the number of buffer modules 40 of the preceding stage of its own module is one, this judgment is affirmative, and the routine moves on to step 272. If the number of buffer modules 40 of the preceding stage is a plural number, the judgment in step 268 is negative, and the routine returns to step 266, and steps 266 and 268 are repeated until the judgment of step 268 becomes affirmative. In this way, unit read data amounts are respectively set for all of the buffer modules 40 of the preceding stage.

In step 272, the control section 388B judges the module of the following stage of its own module. In a case in which the module of the following stage of its own module is other than the buffer module 40, e.g., is the image outputting section 24 or a specific file or the like, initializing processing thereof is carried out in step 278 as needed, and the routine moves on to step 280. For example, if the module of the following stage is the image outputting section 24 which is formed from any of an image recording section, a display section, a writing device, or a transmitting section, processing such as notifying that image data is to be outputted in units of a data amount which corresponds to the unit write data amount, or the like are carried out with respect to the image outputting section 24 as the aforementioned initializing processing. Further, if the module of the following stage is the buffer module 40, the data amount of the image data in the writing of image data of one time (i.e., the unit write data amount) is recognized in step 274. That unit write data amount is set at the buffer module of the following stage in step 276 (refer also to (2) of FIG. 13A), and thereafter, the routine moves on to step 280. In step 280, the module generating section 44 is notified that this image processing module initializing processing is completed, and the image processing module initializing processing ends.

On the other hand, when the buffer control section 40B of the individual buffer module 40 structuring the image processing section 50 is started-up by the module generating section 44 or the application 32, the buffer control section 40B carries out the buffer control processing shown in FIGS. 5A and 5B. In this buffer control processing, when the buffer control section 40B is started-up by the module generating section 44 or the application 32 and generation of the buffer module 40 is instructed, a number of waiting requests is initialized to 0 in step 356. In next step 358, it is judged whether or not a unit write data amount is notified from the image processing module 38 of the preceding stage of its own module or a unit read data amount has been notified from the image processing module 38 of the following stage of its own module. If the judgment is negative, the routine moves on to step 362 where it is judged whether or not unit write data amounts or unit read data amounts have been notified from all of the image processing modules 38 connected to its own module. If the judgment is negative, the routine returns to step 358, and steps 358 and 362 are repeated until the judgment of step 358 or step 362 is affirmative.

When the unit write data amount or the unit read data amount is notified from the specific image processing module 38 connected to its own module, the judgment in step 358 is affirmative, and the routine moves on to step 360 where the notified unit write data amount or unit read data amount is stored. Thereafter, the routine returns to step 358. Accordingly, each time the unit write data amount or the unit read data amount is notified from the individual image processing modules 38 due to the processing of step 266 or step 276 of the image processing module initializing processing (FIGS. 11A and 11B) being carried out by the control sections 38B of the individual image processing modules 38 connected to its own module, the notified unit write data amount or unit read data amount is stored, and the notified unit write data amount or unit read data amount is thereby set at the buffer module 40 (refer to (1) and (2) of FIG. 13B as well).

When the unit write data amounts or the unit read data amounts from all of the image processing modules 38 connected to its own module are notified, and the notified unit write data amounts and unit read data amounts are respectively set, the judgment in step 362 is affirmative, and the routine proceeds to step 364. In step 364, on the basis of the unit write data amounts and the unit read data amounts respectively set by the individual image processing modules 38 connected to its own module, the buffer control section 40B determines the size of a unit buffer region which is the managing unit of the buffer 40A of its own module, and stores the determined size of the unit buffer region. The maximum value of the unit write data amount and the unit read data amount which are set at its own module is suitable for the size of the unit buffer region. However, the unit write data amount may be set as the size of the unit buffer region, or the unit read data amount (in a case in which plural image processing modules 38 are connected at the following stage of its own module, the maximum value of the unit read data amounts which are respectively set by the individual image processing modules 38) may be set as the size of the unit buffer region. Or, the least common multiple of the unit write data amount and the (maximum value of the) unit read data amount(s) may be set. Or, if this least common multiple is less than a predetermined value, the least common multiple may be set, or if the least common multiple is greater than or equal to the predetermined value, another value (e.g., any of the aforementioned maximum value of the unit write data amount and unit read data amount(s), or the unit write data amount, or the (maximum value of the) unit read data amount(s)) may be set as the size of the unit buffer region.

In next step 366, the buffer control section 40B judges whether or not a memory region, which is used as the buffer 40A of its own module, is already provided. If its own module is generated by the module generating section 44, this judgment is negative, and a buffer flag is set to 0 in step 368. Thereafter, the routine moves on to step 374. Further, if its own module is generated by the application 32 and is a buffer module 40 which functions as the image data supplying section 22 or the image outputting section 24, the memory region which is used as the buffer 40A of its own module already exists. Therefore, the judgment of step 366 is affirmative, and the routine moves on to step 370. In step 370, the size of the unit buffer region which was determined in previous step 364 is changed to the size of the established memory region which is used as the buffer 40A of its own module. Further, in next step 372, the buffer flag is set to 1, and thereafter, the routine proceeds to step 374.

In step 374, the buffer control section 40B generates respective effective data pointers which correspond to the individual image processing modules 38 of the following stage of its own module, and initializes the respective generated effective data pointers. The effective data pointers are pointers which indicate the head position (the next reading start position) and the end position respectively of the image data (effective data) which is not read by the corresponding image processing module 38 of the following stage, among the image data which is written in the buffer 40A of its own module by the image processing module of the preceding stage of its own module. In the initializing processing of step 374, usually, specific information which means that effective data does not exist is set. If its own module is generated by the application 32 and is the buffer module 40 which functions as the image data supplying section 22, there are cases in which image data which is the object of image processing is already written in the memory region which is used as the buffer 40A of its own module. In such cases, the head position and the end position of that image data are respectively set as the effective data pointers which correspond to the individual image processing modules 38 of the following stage.

The initializing processing at the buffer module 40 is completed by the above-described processing, and in next step 376, the workflow managing section 46A is notified of the completion of the initialization processing. Further, in step 378, it is judged whether or not a value which is greater than 0 is set as the number of waiting requests for which initial setting was carried out in previous step 356. If the judgment is negative, the routine moves on to step 380, and it is judged whether or not a deletion notice, which gives notice that the processing of deleting that image processing module 38 is to be carried out, has been received from the image processing module 38 connected at the preceding stage or the following stage of its own module. If this judgment as well is negative, the routine returns to step 378, and step 378 and step 380 are repeated until either of the judgments is affirmative.

On the other hand, when the constructing of the image processing section 50 which carries out the needed image processing is completed due to the above-described module generating processing (FIG. 3A) being successively carried out by the module generating sections 44 which the application 32 successively started-up, the application 32 starts-up threads (or processes or objects) which execute the programs of the workflow managing section 46A, and thereby instructs the workflow managing section 46A to execute the image processing by the image processing section 50 (refer also to step 176 of FIGS. 2A and 2B).

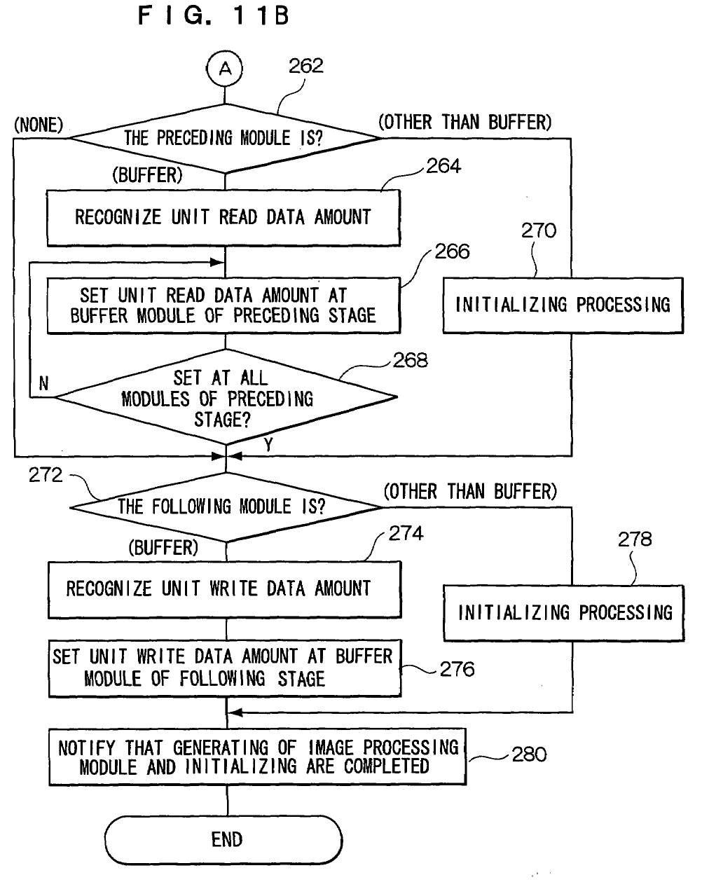

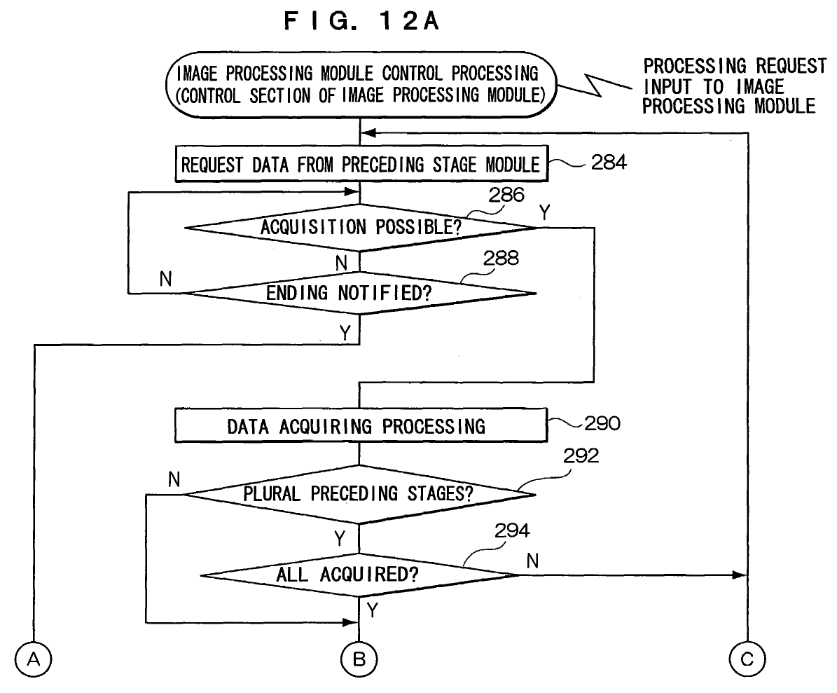

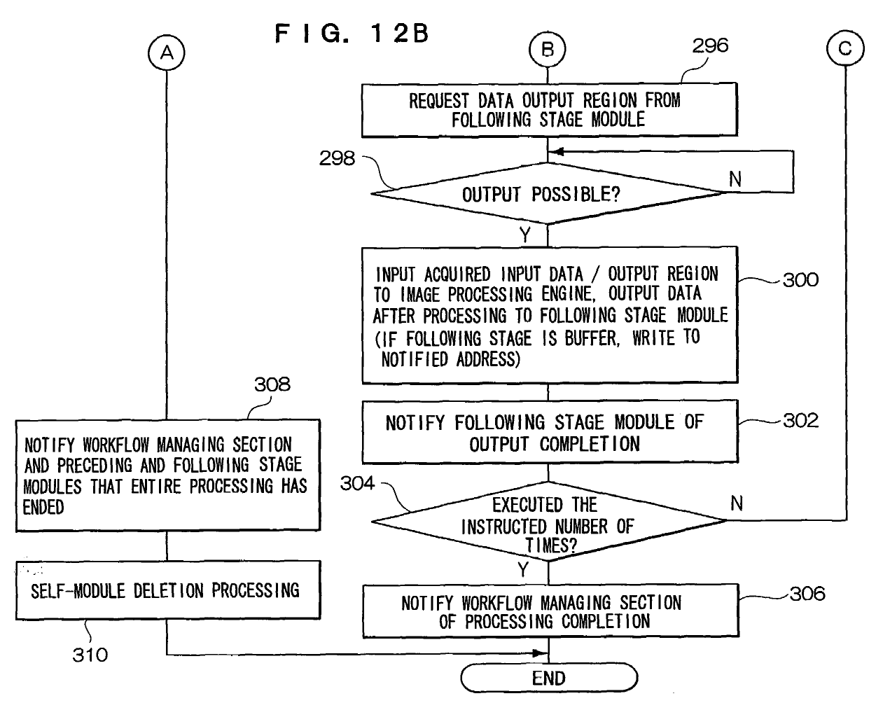

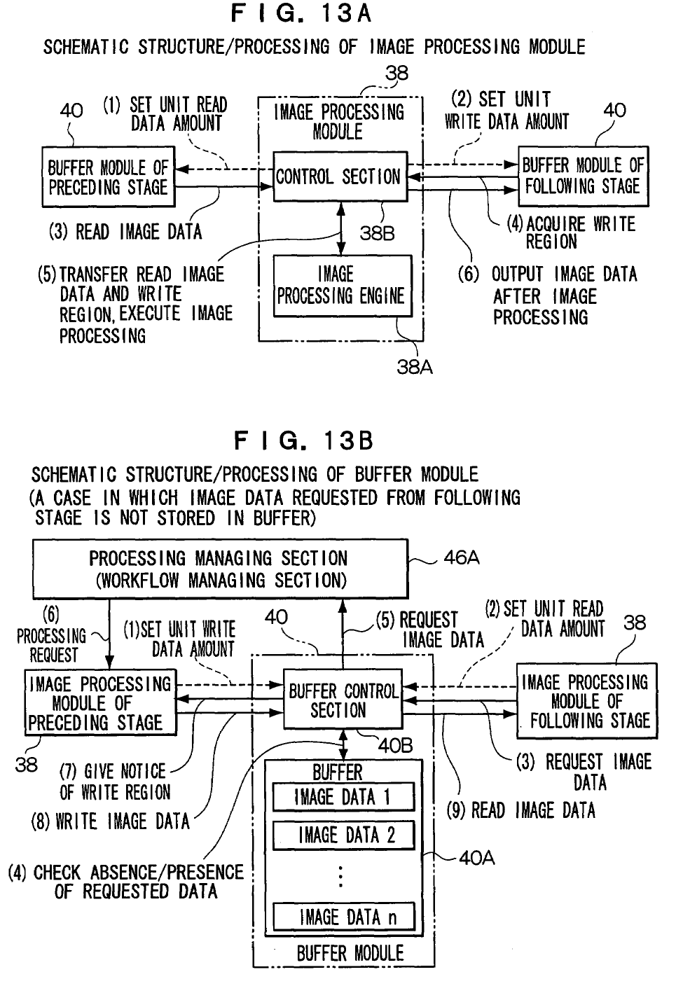

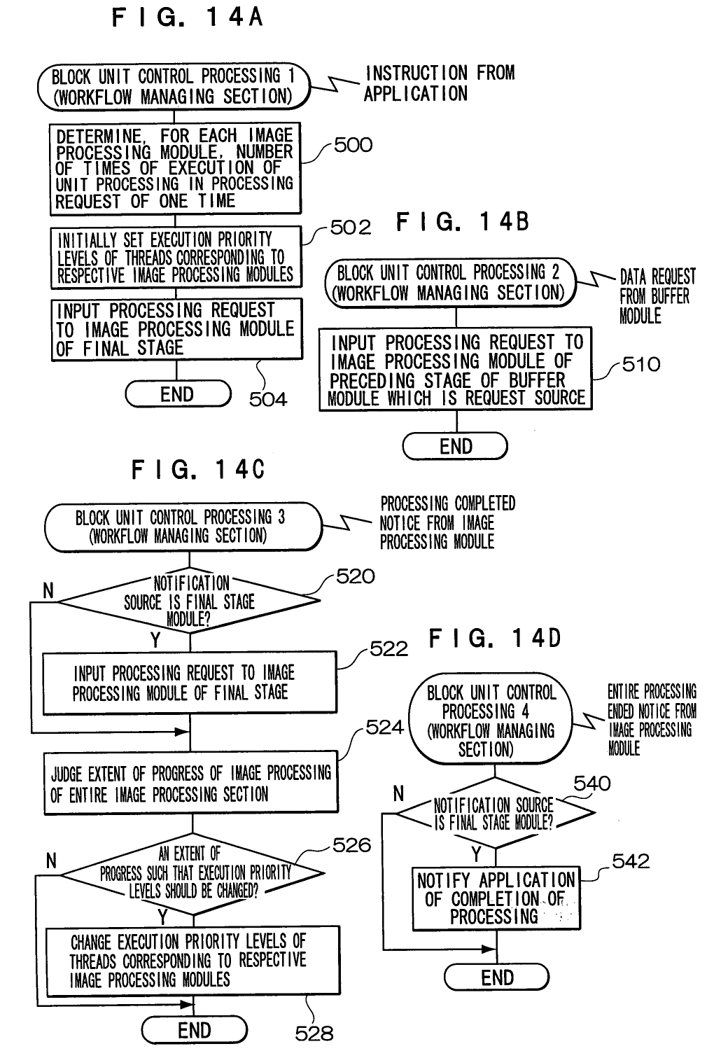

Due to the programs being started-up, the workflow managing section 46A of the processing managing section 46 carries out the block unit control processing shown in FIGS. 14A through 14D. Note that the block unit processing corresponds to the image processing section control processing shown in step 178 of FIGS. 2A and 2B. In the block unit processing, due to the workflow managing section 46A inputting a processing request to a predetermined image processing module 38 among the image processing modules 38 structuring the image processing section 50, image processing by the image processing section 50 is carried out a form of execution of block units. Hereinafter, before the overall operation of the image processing section 50 is described, the processing after the completion of the initialization processing carried out by the buffer control sections 40B of the individual buffer modules 40, and the image processing module control processing carried out by the control sections 38B of the individual image processing modules 38, will be described in that order.

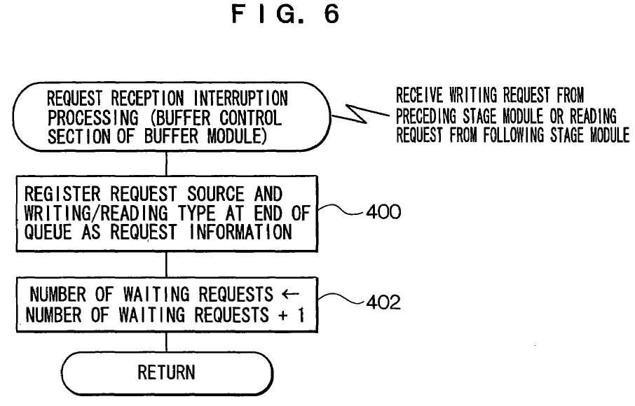

In the exemplary embodiments of the present invention, in a case in which the image processing module 38 writes image data to the buffer module 40 of the following stage, a writing request is inputted from the image processing module 38 to the buffer module 40. In a case in which the image processing module 38 reads image data from the buffer module 40 of the preceding stage, a reading request is inputted from the image processing module 38 to the buffer module 40. Therefore, when a writing request is inputted from the image processing module 38 of the preceding stage of its own module, or when a data request is inputted from the image processing module 38 of the following stage of its own module, the buffer control section 40B of the buffer module 40 carries out the request reception interruption processing shown in FIG. 6 due to an interruption arising. Note that, hereinafter, description which is premised on the occurrence of an interruption is given, but processing may start due to the calling-up of a method or function, as in a usual program. In this case, a structure may be used in which processing is carried out for each request, and requests are not queued in a queue as in the following description.

In the request reception interruption processing, first, in step 400, request source identifying information which identifies the request source which inputted the writing request or the data request to its own module, and request type information which expresses the type of the request (write or read), are registered at the end of the queue as request information. These queues are formed respectively on the memories which are allotted to the individual buffer modules 40. Further, in next step 402, the number of waiting requests is increased by one, and the request reception interruption processing ends. Due to this request reception interruption processing, each time a writing request or a reading request is inputted to a specific buffer module 40 from the image processing module of the preceding stage or the following stage of the specific buffer module 40, the request information corresponding to the inputted writing request or reading request is successively registered in the queue corresponding to the specific buffer module 40, and the number of waiting requests is increased one-by-one.

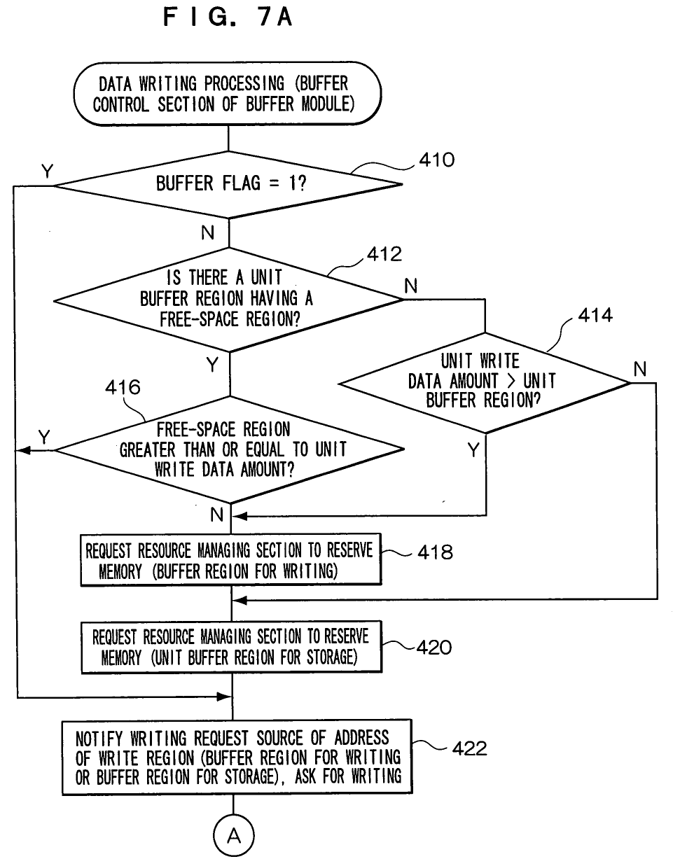

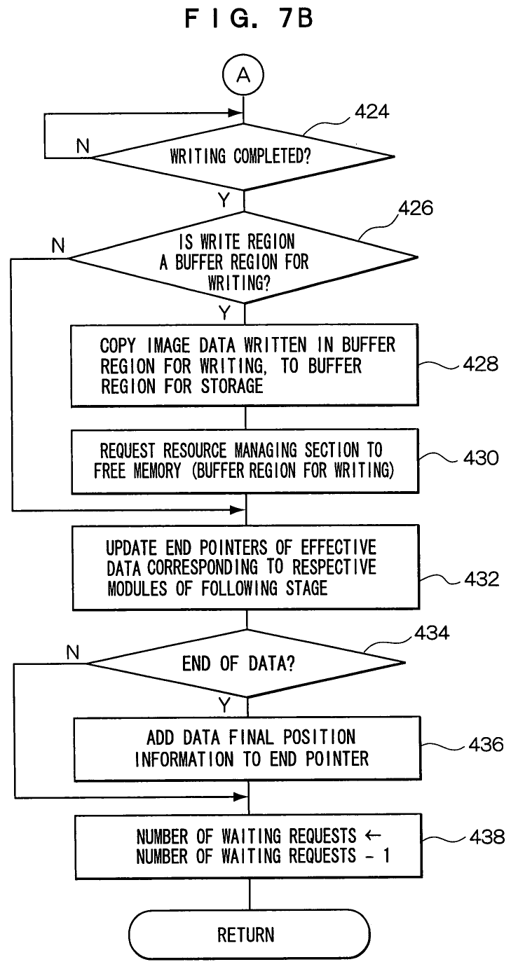

When the number of waiting requests becomes a value which is greater than or equal to 1 due to the above-described request reception interruption processing being executed, the judgment of step 378 of the buffer control processing (FIGS. 5A and 5B) is affirmative, and the routine moves on to step 382 where the request information is taken-out from the head of the queue. In next step 384, on the basis of the request type information which is included in the request information taken-out in step 382, the type (writing or reading) of the request corresponding to the taken-out request information is judged, and the routine splits in accordance with the results of this judgment. If the type of request is a writing request, the routine moves on from step 384 to step 386, and the data writing processing shown in FIGS. 7A and 7B is carried out.

In the data writing processing, first, in step 410, it is judged whether or not 1 is set for the buffer flag, i.e., whether or not its own module is the buffer module 40 generated by the application 32. If this judgment is affirmative, because the memory region used as the buffer 40A is already reserved, the routine moves on to step 422 without any processing being carried out. Further, if the judgment in step 410 is negative, i.e., if its own module is the buffer module 40 generated by the module generating section 44, the routine proceeds to step 412. In step 412, it is judged whether or not there exists, among the unit buffer regions structuring the buffer 40A of its own module, a unit buffer region having a free-space region (a unit buffer region in which image data is not written to the end thereof).

At the buffer module 40 which is generated by the module generating section 44, a memory region (unit buffer region) used as the buffer 40A is not reserved initially, and a unit buffer region is reserved as a unit each time a shortage of memory regions arises. Therefore, when a writing request is first inputted to the buffer module 40, a memory region (unit buffer region) which is used as the buffer 40A does not exist, and this judgment is negative. Further, also after a unit buffer region which is used as the buffer 40A is reserved through processing which will be described later, the aforementioned judgment is negative in a case in which that unit buffer region just becomes full as the image data is written to that unit buffer region.

If the judgment in step 412 is negative, the routine moves on to step 414. In step 414, the image processing module 38 which is the source of the writing request is recognized on the basis of the request source identification information included in the request information taken-out from the queue, and the unit write data amount set by the image processing module 38 which is the source of the writing request is recognized, and thereafter, it is judged whether or not the recognized unit write data amount is greater than the size of the unit buffer region determined in previous step 364 (FIGS. 5A and 5B). In cases of employing, as the size of the unit buffer region, the maximum value of the unit write data amount and the unit read data amount set at its own module, or the unit write data amount set at its own module, this judgment is always negative, and the routine moves on to step 420. In step 420, the resource managing section 46B is notified of the size of the memory region which is to be reserved (the size of the unit buffer region), and the resource managing section 46B is requested to reserve a memory region (a unit buffer region used in storing image data) which is used as the buffer 40A of its own module. In this way, the unit buffer region is reserved by the resource managing section 46B.

Further, in a case in which there exists, among the unit buffer regions structuring the buffer 40A of its own module, a unit buffer region having a free-space region, the judgment in step 412 is affirmative, and the routine proceeds to step 416. In step 416, in the same way as in above-described step 414, the unit write data amount set by the image processing module 38 which is the source of the writing request is confirmed, and thereafter, it is judged whether or not the size of the free-space region in the unit buffer region having a free-space region is greater than or equal to the confirmed unit write data amount. If the judgment is affirmative, there is no need to newly reserve a unit buffer region which is used as the buffer 40A of its own module, and therefore, the routine moves on to step 422 without any processing being carried out.

If the size of the unit buffer region is an integer multiple of the unit write data amount, each time a writing request is inputted from the image processing module 38 of the preceding stage of its own module, either the judgments of steps 412, 414 are both negative or the judgments of steps 412, 416 are both affirmative as described above, and only the unit buffer region which is used as the buffer 40A is reserved as needed.

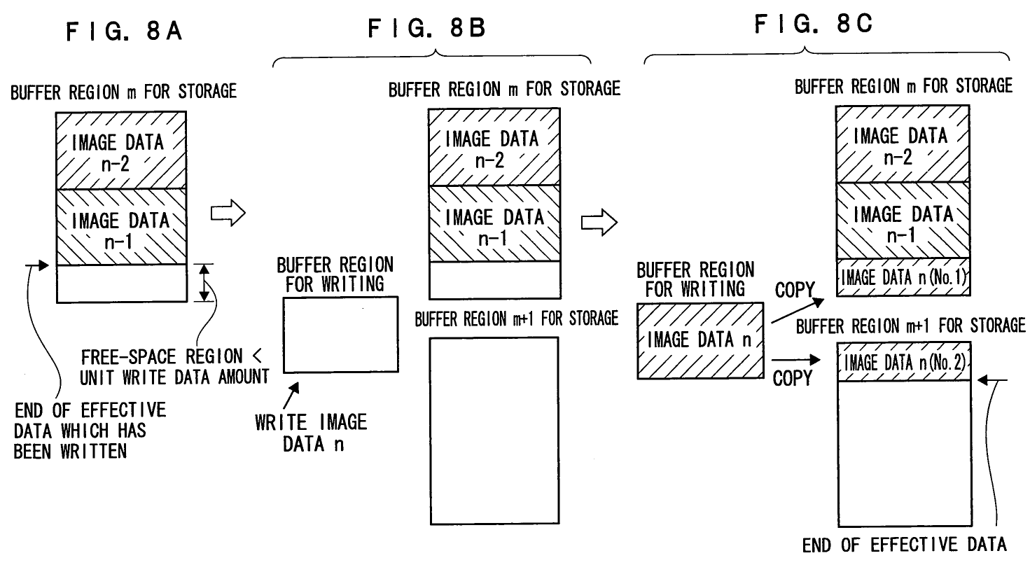

On the other hand, in a case in which the size of the unit buffer region is not an integer multiple of the unit write data amount, by repeating the writing of the image data of the unit write data amount to the buffer 40A (the unit buffer region), a state arises in which the size of the free-space region at the unit buffer region having a free-space region is smaller than the unit write data amount (the judgment of step 416 is affirmative), as shown as an example in FIG. 8A. Further, in the exemplary embodiments of the present invention, it is also possible to employ the unit read data amount set at its own module (or the maximum value thereof) as the size of the unit buffer region. However, if the size thereof is smaller than the unit write data amount (i.e., if the judgment in step 414 is affirmative), the aforementioned state always arises when a writing request is inputted.

As described above, in a case in which the size of the free-space region in the unit buffer region having a free-space region is smaller than the unit write data amount, the region in which the image data of the unit write data amount is written extends over plural unit buffer regions. However, in the exemplary embodiments of the present invention, because the memory region which is used as the buffer 40A is reserved in units of the unit buffer region, it is not possible to ensure that unit buffer regions which are reserved at different times will be regions which are continuous on the actual memory (the memory 14). Therefore, in a case in which the region in which the image data is written extends over plural unit buffer regions, i.e., in a case in which the judgment in step 416 is negative or the judgment in step 414 is affirmative, the routine moves on to step 418. In step 418, the resource managing section 46B is notified of the unit write data amount as the size of the memory region which is to be reserved, and the resource managing section 46B is requested to reserve a memory region to be used for writing (a buffer region for writing: refer to FIG. 8B as well). Then, when the buffer region for writing is reserved, in next step 420, reserving of the unit buffer region which is used as the buffer 40A is carried out.

In step 422, if the size of the free-space region in the unit buffer region having a free-space region is greater than or equal to the unit write data amount, that free-space region is made to be the write region. On the other hand, if the size of the free-space region in the unit buffer region having a free-space region is smaller than the unit write data amount, the buffer region for writing which is newly reserved is made to be the write region, and the image processing module 38 which is the source of the writing request is notified of the head address of that write region, and is asked to write the image data which is the object of writing, in order from the notified head address. In this way, the image processing module 38 which is the source of the writing request writes the image data to the write region whose head address has been notified (the unit buffer region or the buffer region for writing) (see FIG. 8B as well). As described above, if the region in which the image data is written extends over plural unit buffer regions, the buffer region for writing is reserved separately. Therefore, regardless of whether or not the region in which the image data is written extends over plural unit buffer regions, the notification of the write region to the image processing module 38 which is the source of the writing request is achieved merely by giving notice of the head address thereof as described above, and the interface with the image processing module 38 is simple.

In next step 424, it is judged whether or not the writing of the image data to the write region by the image processing module 38 of the preceding stage is completed, and step 424 is repeated until the judgment is affirmative. When notice of the completion of writing is given from the image processing module 38 of the preceding stage, the judgment of step 424 is affirmative, and the routine moves on to step 426. In step 426, it is judged whether or not the write region in the above-described writing processing is the buffer region for writing which was reserved in previous step 416. If this judgment is negative, the routine proceeds to step 432 without any processing being carried out. If the judgment of step 426 is affirmative, the routine proceeds to step 428. In step 428, as shown as an example in FIG. 8C, the image data written to the buffer region for writing is copied in a state of being divided between the unit buffer region having a free-space region and the new unit buffer region reserved in previous step 422. Further, in step 430, the resource managing section 46B is notified of the head address of the memory region which was reserved as the buffer region for writing in previous step 418, and the resource managing section 46B is requested to free that memory region, and the memory region is freed by the resource managing section 46B.

Note that, here, explanation is given of an aspect in which the buffer region for writing is reserved when needed, and is freed right away when it is no longer needed. However, in a case in which the size of the unit buffer region for storage is not an integer multiple of the unit write data amount, the buffer region for writing is absolutely necessary. Therefore, a structure may be used in which it is reserved at the time of initialization and freed at the time when the buffer module 40 is deleted.

In the data writing processing (FIGS. 7A and 7B), the routine moves on to step 432 when the judgment in step 426 is negative, or when notification of the completion of freeing is given from the resource managing section 46B after freeing of the memory region is requested in step 430. In step 432, among the effective data pointers corresponding to the individual image processing modules 38 of the following stage of its own module, the pointers expressing the end positions of the effective data are respectively updated (refer to FIG. 8C as well). Note that the updating of the pointer is achieved by moving the end position of the effective data which is indicated by the pointer, rearward by an amount corresponding to the unit write data amount. In a case in which the image data which is written this time by the image processing module 38 of the preceding stage of its own module is data corresponding to the end of the image data which is the object of processing, when the writing processing by the image processing module 38 of the preceding stage is completed, an entire processing ended notice, which expresses that the image data which is the object of processing has ended, is given, and the size of the written image data is inputted from the image processing module 38 of the preceding stage. Therefore, in a case in which an entire processing ended notice is inputted from the image processing module 38 of the preceding stage when writing processing is completed, pointer updating is carried out by moving the end position of the effective data rearward by an amount corresponding to the size which is notified simultaneously.

In next step 434, on the basis of whether or not the entire processing ended notice is inputted at the time of completion of writing processing, it is judged whether or not writing of the image data which is the object of processing to the buffer 40A is completed. If the judgment is negative, the routine moves on to step 438 without any processing being carried out. However, if the judgment is affirmative, the routine proceeds to step 436 where data final position information, which expresses that this is the end of the image data which is the object of processing, is added to the pointer updated in step 432 (the pointer showing the end position of the effective data, among the effective data pointers corresponding to the individual image processing modules 38 of the following stage of its own module). Thereafter, the routine proceeds to step 438. Then, in step 438, the number of waiting requests is reduced by 1, the data writing processing ends, and the routine returns to step 378 of the buffer control processing (FIGS. 5A and 5B).

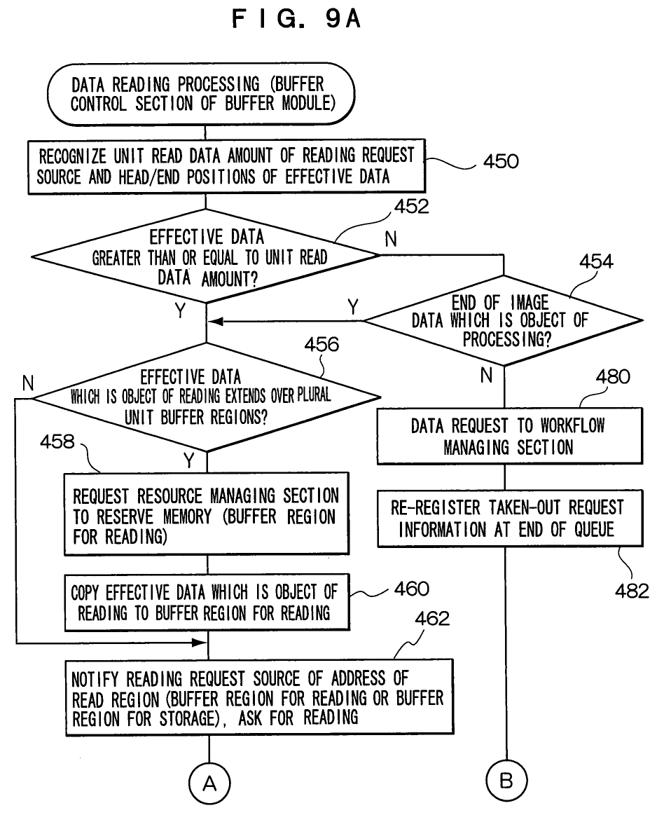

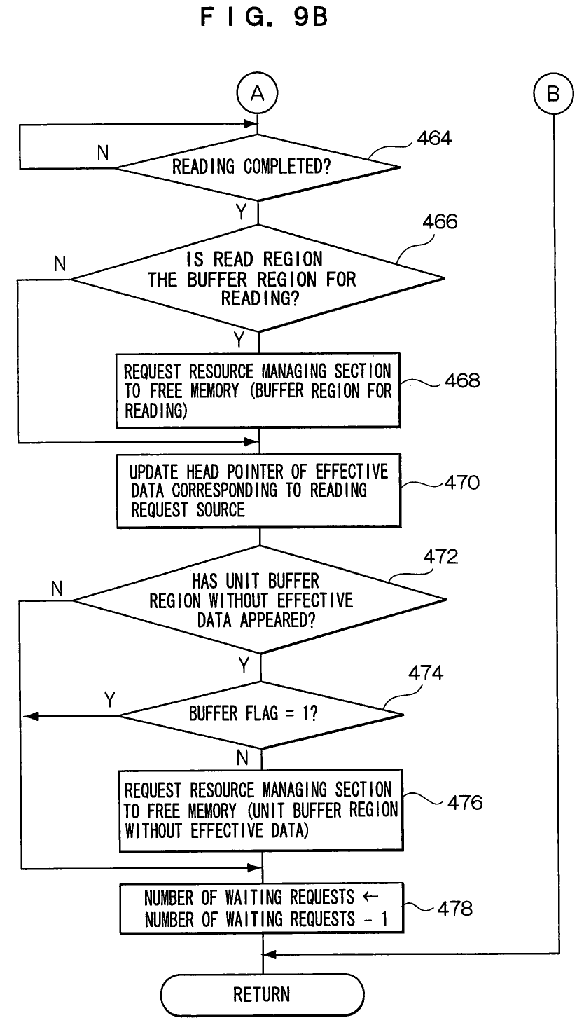

In the buffer control processing (FIGS. 5A and 5B), in a case in which the type of the request corresponding to the request information which was taken-out in step 382 is reading, the routine moves on from step 384 to step 388, and the data reading processing shown in FIGS. 9A and 9B is carried out. In the data reading processing, first, in step 450, on the basis of the request source identification information included in the request information taken-out from the queue, the image processing module 38 which is the source of the reading request is recognized, and the unit read data amount set by the image processing module 38 which is the source of the reading request is recognized, and, on the basis of the effective data pointers corresponding to the image processing module 38 which is the source of the reading request, the head position and the end position on the buffer 40A of the effective data corresponding to the image processing module 38 which is the source of the reading request are recognized. In next step 452, on the basis of the head position and the end position of the effective data which were recognized in step 450, it is judged whether or not the effective data corresponding to the image processing module 38 which is the source of the reading request (the image data which can be read by the image processing module 38 which is the source of the reading request) is greater than or equal to the unit read data amount.

If this judgment is negative, the routine moves on to step 454 where it is judged whether or not the end of the effective data, which is stored in the buffer 40A and which can be read by the image processing module 38 which is the source of the reading request, is the end of the image data which is the object of processing. The judgment in step 452 or step 454 is affirmative and the routine proceeds to step 456 in cases in which the effective data which corresponds to the image processing module 38 which is the source of the reading request is stored in the buffer 40A in an amount greater than or equal to the unit read data amount, or, although the effective data which is stored in the buffer 40A and corresponds to the image processing module 38 which is the source of the reading request is less than the unit read data amount, the end of this effective data is the end of the image data which is the object of processing. In step 456, on the basis of the head position of the effective data which was recognized in previous step 450, the unit buffer region, which is storing the image data of the head portion of the effective data, is recognized. Further, by judging whether or not the data amount of the effective data stored in the recognized unit buffer region is greater than or equal to the unit read data amount recognized in step 450, it is judged whether or not the effective data which is the object of reading this time extends over plural unit buffer regions.

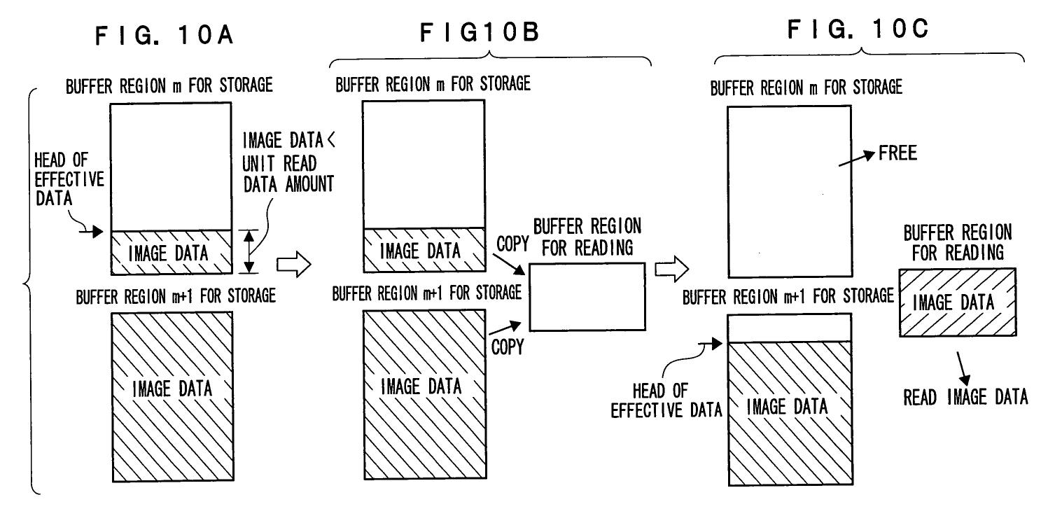

If the judgment of step 456 is negative, the routine proceeds to step 462 without any processing being carried out. Here, as shown in FIG. 10A for example, cases, in which the data amount of the effective data stored in the unit buffer region which stores the image data of the head portion of the effective data is less than the unit read data amount and the effective data which is the object of reading this time extends over plural unit buffer regions, are not limited to the effective data which is the object of reading this time being stored in regions which are continuous on the actual memory (the memory 14). Therefore, if the judgment in step 456 is affirmative, the routine moves on to step 458 where the resource managing section 46B is notified of the unit read data amount corresponding to the image processing module 38 which is the source of the reading request, as the size of the memory region which is to be reserved, and the resource managing section 46B is requested to reserve a memory region which is used in reading (buffer region for reading: see FIG. 8B as well). When the buffer region for reading is reserved, in next step 460, the effective data, which is the object of reading and which is stored over plural unit buffer regions, is copied to the buffer region for reading which was reserved in step 458 (refer to FIG. 10B as well).

In step 462, if the effective data which is the object of reading is stored in a single unit buffer region, the region, which is storing the effective data which is the object of reading, among that unit buffer region is made to be the read region. On the other hand, if the effective data which is the object of reading is stored over plural unit buffer regions, the buffer region for reading is used as the read region. The image processing module 38 which is the source of the reading request is notified of the head address of that read region, and is asked to read the image data in order from the notified head address. In this way, the image processing module 38 which is the source of the reading request carries out reading of the image data from the read region whose head address was notified (the unit buffer region or the buffer region for reading) (see FIG. 10C as well). Note that, in a case in which the effective data which is the object of reading is data corresponding to the end of the image data which is the object of processing (i.e., in a case in which the end position of the effective data which is the object of reading coincides with the end position of the effective data which is indicated by the effective data pointer corresponding to the image processing module 38 which is the source of the reading request, and data final position information is added to the pointer), at the time of the asking for reading of the image data, the image processing module 38 which is the source of the reading request is also notified of the size of the effective data which is the object of reading and of the fact that this is the end of the image data which is the object of processing.

As described above, in a case in which the effective data which is the object of reading is stored so as to extend over plural unit buffer regions, the effective data which is the object of reading is copied to the buffer region for reading which is reserved separately. Therefore, regardless of whether or not the effective data which is the object of reading is stored over plural unit buffer regions, the notification of the read region to the image processing module 38 which is the source of the reading request is achieved merely by giving notice of the head address thereof as described above, and the interface with the image processing module 38 is simple. Note that, in a case in which its own module is the buffer module 40 generated by the application 32, the memory region used as the buffer 40A (the aggregate of the unit buffer regions) is a continuous region. Therefore, the following is possible: before carrying out the judgment of step 456, it is judged whether or not the buffer flag is 1, and if the judgment is affirmative, the routine moves on to step 462 regardless of whether or not the effective data which is the object of reading is stored over plural unit buffer regions.

In next step 464, it is judged whether or not reading of the image data from the read region by the image reading module 38 which is the source of the reading request is completed, and step 464 is repeated until this judgment is affirmative. When the completion of reading is notified from the image processing module 38 which is the source of the reading request, the judgment of step 464 is affirmative, and the routine proceeds to step 466 where it is judged whether or not the read region in the above-described reading processing is the buffer region for reading which was reserved in previous step 458. If the judgment is negative, the routine proceeds to step 470 without any processing being carried out. If the judgment in step 466 is affirmative, the routine moves on to step 468 where the resource managing section 46B is notified of the size and the head address of the memory region which was reserved as the buffer region for reading in previous step 458, and the resource managing section 46B is requested to free that memory region. For the buffer region for reading as well, in the same way as with the buffer region for writing, if the size of the unit buffer region for storage is not an integer multiple of the unit read data amount, the buffer region for reading is absolutely necessary. Therefore, a structure may be used in which it is reserved at the time of initialization and freed at the time when the buffer module 40 is deleted.

In next step 470, among the effective data pointers corresponding to the image processing module 38 which is the source of the reading request, the pointer indicating the head position of the effective data is updated (refer also to FIG. 10C). Note that the updating of the pointer is achieved by moving the head position of the effective data which is indicated by the pointer, rearward by an amount corresponding to the unit read data amount. If the effective data which is the object of reading this time is data corresponding to the end of the image data which is the object of processing, pointer updating is carried out by moving the head position of the effective data rearward by an amount corresponding to the size of the effective data which is the object of reading this time which was notified also to the image processing module 38 which is the source of the reading request.

In step 472, the effective data pointers corresponding to the individual image processing modules 38 of the following stage are respectively referred to, and it is judged whether or not, due to the pointer updating of step 470, a unit buffer region for which reading of the stored image data by the respective image processing modules 38 of the following stage has all been completed, i.e., a unit buffer region in which no effective data is stored, has appeared among the unit buffer regions structuring the buffer 40A. If the judgment is negative, the routine proceeds to step 478 without any processing being carried out. If the judgment is affirmative, the routine proceeds to step 474 where it is judged whether or not the buffer flag is 1. If its own module is the buffer module 40 generated by the module generating section 44, the judgment is negative and the routine proceeds to step 476 where the resource managing section 46B is requested to free the unit buffer region in which no effective data is stored.

Note that, if its own module is the buffer module 40 generated by the application 32, the judgment in step 474 is affirmative, and the routine moves on to step 478 without any processing being carried out. Accordingly, if a buffer region (memory region) designated by the user is used as the buffer 40A, the buffer region is stored without being freed. Then, in step 478, the number of waiting requests is decreased by 1, the data reading processing ends, and the routine returns to step 378 of the buffer control processing (FIGS. 5A and 5B).

On the other hand, in a case in which the data amount of the effective data which is stored in the buffer 40A and which can be read by the image processing module 38 which is the source of the reading request is less than the unit read data amount, and the end of the effective data which can be read is not the end of the image data which is the object of processing (i.e., in a case in which it is sensed that there is no readable effective data in (4) of FIG. 13B), the judgments of steps 452 and 454 are both negative, and the routine proceeds to step 480 where a data request, which requests new image data, is outputted to the workflow managing section 46A (see (5) in FIG. 13B as well). In this case, a processing request is inputted by the workflow managing section 46A to the image processing module 38 of the preceding stage of its own module. Further, in step 482, the request information, which was taken-out from the queue in previous step 382 (FIGS. 5A and 5B), is again registered at the end of the original queue, and the data reading processing ends.

As shown in FIGS. 5A and 5B, when the data reading processing ends, the routine returns to step 378 (FIGS. 5A and 5B). Therefore, in this case, if no other request information is registered in the queue, the request information which is registered again at the end of the queue is immediately taken-out again from the queue, and the data reading processing of FIGS. 9A and 9B is again executed. If other request information is registered in the queue, the other request information is taken-out and processing corresponding thereto is carried out, and thereafter, the request information which is registered again at the end of the queue is again taken-out from the queue, and the data reading processing of FIGS. 9A and 9B is executed again. Accordingly, in a case in which a reading request from the image processing module 38 of the following stage is inputted but the data amount of the effective data which can be read by the image processing module 38 which is the source of the reading request is less than the unit read data amount, and the end of the effective data which can be read is not the end of the image data which is the object of processing, the corresponding request information is stored and the data reading processing is executed repeatedly until either the data amount of the effective data which can be read becomes greater than or equal to the unit read data amount, or it is sensed that the end of the effective data which can be read is the end of the image data which is the object of processing (i.e., until the judgment of step 452 or step 454 is affirmative).

Although details thereof will be described later, when a data request is inputted from the buffer module 40, the workflow managing section 46A inputs a processing request to the image processing module 38 of the preceding stage of the buffer module 40 which is the source of the data request (refer to (6) in FIG. 13B as well). Due to processing which is triggered by the input of this processing request and which is carried out at the control section 38B of the image processing module 38 of the preceding stage, when the image processing module 38 of the preceding stage, becomes able to write image data to the buffer module 40, due to a writing request being inputted from the image processing module 38 of the preceding stage, the above-described data writing processing (FIGS. 7A and 7B) is carried out, and image data is written to the buffer 40A of the buffer module 40 from the image processing module 38 of the preceding stage (refer also to (7), (8) of FIG. 13B). In this way, reading of the image data from the buffer 40A by the image processing module 38 of the following stage is carried out (refer also to (9) of FIG. 13B).

As described above, in the buffer control processing relating to the exemplary embodiments of the present invention, each time either a writing request is inputted from the image processing module 38 of the preceding stage or a reading request is inputted from the image processing module of the following stage, the inputted request is registered in a queue as request information, and the request information is taken-out one-by-one from the queue and processed. Therefore, even in cases such as when a reading request is inputted during execution of the data writing processing or a writing request is inputted during execution of the data reading processing, exclusive control, which stops execution of the processing corresponding to the inputted request, is carried out until the processing being executed is completed and a state arises in which processing corresponding to the inputted request can be executed. In this way, even if the CPU 12 of the computer 10 executes, in parallel, threads (or processes) corresponding to individual modules structuring the image processing section 50, it is possible to avoid the occurrence of problems due to plural requests being inputted simultaneously or substantially simultaneously to a single buffer module 40. Therefore, the CPU 12 of the computer 10 can execute, in parallel, threads (or processes) corresponding to individual modules. Of course, the buffer module may be realized as a usual program or object.

Next, description will be given of image processing module control processing (FIGS. 12A and 12B) which is carried out by the respective control sections 38B of the individual image processing modules 38, each time a processing request is inputted from the workflow managing section 46A to the individual image processing modules 38 structuring the image processing section 50. In the image processing module control processing, first, in step 284, in a case in which a module (the buffer module 40, or the image data supplying section 22, the image processing module 38, or the like) exists at the preceding stage of its own module, data (image data, or the results of processing of image processing such as analysis or the like) is requested from that module of the preceding stage. In next step 286, it is judged whether data can be acquired from the module of the preceding stage. If the judgment is negative, in step 288, it is judged whether or not notification has been given of the ending of the entire processing. If the judgment in step 288 is affirmative, in step 308, the control section 38B notifies the workflow managing section 46A and the modules at the preceding stage and the following stage of its own module that the entire processing has ended, and thereafter, in step 310, carries out self-module deletion processing (to be described later).

On the other hand, if the judgment of step 288 is negative, the routine returns to step 286, and steps 286 and 288 are repeated until it becomes possible to acquire data from the module of the preceding stage. If the judgment in step 286 is affirmative, in step 290, data acquiring processing, which acquires data from the module of the preceding stage, is carried out.

Here, in a case in which the module of the preceding stage of its own module is the buffer module 40, when data is requested in previous step 284 (a reading request), immediately, the head address of the read region is notified from the buffer module 40 and reading of the data is asked for (see step 462 in FIGS. 9A and 9B), if there is a state in which the effective data which can be read is stored in the buffer 40A of the buffer module 40 in an amount which is greater than or equal to the unit read data amount, or the end of the effective data which can be read coincides with the end of the image data which is the object of processing. If neither of these states exists, as the image processing module 38 of the preceding stage of the buffer module 40 writes image data to the buffer 40A of that buffer module 40, the state changes to the aforementioned state, and thereafter, the head address of the read region is notified from the buffer module 40 and reading of the image data is asked for (see step 462 of FIGS. 9A and 9B). In this way, the judgment of step 286 is affirmative, and the routine proceeds to step 290. In step 290, data acquiring processing, which reads image data of the unit read data amount (or a data amount less than that) from the read region whose head address has been notified from the buffer module 40 of the preceding stage, is carried out (refer to (3) in FIG. 13A as well).

Further, if the module of the preceding stage of its own module is the image data supplying section 22, when a data request is outputted in previous step 284, notification is given immediately from the image data supplying section 22 of the preceding stage that there is a state in which image data can be acquired. In this way, the judgment of step 286 is affirmative, and the routine proceeds to step 290 where image data acquiring processing, which acquires image data of the unit read data amount from the image data supplying section 22 of the preceding stage, is carried out. Further, if the module of the preceding stage of its own module is the image processing module 38, when a data request (processing request) is outputted in previous step 284, if there is a state in which the image processing module 38 of the preceding stage can execute image processing, due to a writing request being inputted, notification is given that there is a state in which data (the results of image processing) can be acquired. Therefore, the judgment of step 286 is affirmative, and the routine proceeds to step 290. Due to the image processing module 38 of the preceding stage giving notice of the address of the buffer region in which data is to be written and asking for writing, data acquiring processing is carried out which writes, to that buffer, the data outputted from the image processing module 38 of the preceding stage.

In next step 292, the control section 38B judges whether or not plural modules are connected at the preceding stage of its own module. If the judgment is negative, the routine moves on to step 296 without any processing being carried out. If the judgment is affirmative, the routine proceeds to step 294 where it is judged whether or not data has been acquired from all of the modules connected at the preceding stage. If the judgment in step 294 is negative, the routine returns to step 284, and step 284 through step 294 are repeated until the judgment of step 294 is affirmative. When all of the data which is to be acquired from the modules of the preceding stage is gathered, either the judgment of step 292 is negative or the judgment of step 294 is affirmative, and the routine moves on to step 296.

Next, in step 296, the control section 38B requests the module of the following stage of its own module for a region for data output. In step 298, judgment is repeated until a data output region can be acquired (i.e., until the head address of a data output region is notified). Note that, if the module of the following stage is the buffer module 40, the aforementioned request for a region for data output is formed by outputting a writing request to that buffer module 40. When a data output region (if the module of the following stage is the buffer module 40, a write region whose head address is notified from that buffer module 40) can be acquired (refer to (4) in FIG. 13A as well), in next step 300, the data obtained by the previous data acquiring processing and (the head address of) the data output region acquired from the module of the following stage are inputted to the image processing engine 38A. A predetermined image processing is carried out on the inputted data (see (5) of FIG. 13A as well), and the data after processing is written to the data output region (see (6) of FIG. 13A as well). When input of data of the unit read data amount to the image processing engine 38A is completed and the data outputted from the image processing engine 38A is all written to the data output region, in next step 302, the module of the following stage is notified that output is completed.

Due to above-described step 284 through step 302, the processing of data of the unit processing data amount (i.e., unit processing) at the image processing module 38 is completed. However, there are cases in which the number of times of execution of the unit processing is designated by the workflow managing section 46A in the processing request which is inputted from the workflow managing section 46A to the image processing module 38. Therefore, in step 304, it is judged whether or not the number of times of execution of the unit processing has reached the number of times of execution instructed by the inputted processing request. If the instructed number of times of execution of the unit processing is one time, this judgment is unconditionally affirmative. However, if the instructed number of times of execution of the unit processing is greater than or equal to 2, the routine returns to step 284, and step 284 through step 304 are repeated until the judgment of step 304 is affirmative. When the judgment of step 304 is affirmative, the routine proceeds to step 306. In step 306, by outputting a processing completed notice to the workflow managing section 46A, the control section 38B notifies the workflow managing section 46A that processing corresponding to the inputted processing request is completed, and the image processing module control processing ends.

Further, when processing is carried out until the end of the image data which is the object of processing due to the above-described processing being repeated each time a processing request is inputted from the workflow managing section 46A, the judgment of step 288 becomes affirmative due to notice of the end of the image data which is the object of processing being given from the module of the preceding stage, and the routine moves on to step 308. In step 308, the control section 38B outputs an entire processing completed notice, which means that processing of the image data which is the object of processing is completed, to the workflow managing section 46A and to the module of the following stage. In next step 310, self-module deletion processing (to be described later) is carried out, and the image processing module control processing ends.

On the other hand, when the workflow managing section 46A is started-up by the application 32, the workflow managing section 46A carries out the block unit control processing 1 shown in FIG. 14A. As described above as well, in the input of a processing request from the workflow managing section 46A to the individual image processing modules 38 of the image processing section 50, it is possible to designate the number of times of execution of the unit processing. In step 500 of the block unit control processing 1, the number of times of execution of the unit processing designated in a processing request of one time is set for each of the individual image processing modules 38. The number of times of execution of the unit processing per processing request of one time can be determined such that, for example, the number of times of input of the processing request to the individual image processing modules 38 during the time that all of the image data which is the object of processing is being processed, is averaged, or may be determined in accordance with another standard. The processing of step 502 will be described later. Then, in next step 504, a processing request is inputted to the image processing module 38 of the final stage of the image processing section 50 (refer to (1) of FIG. 15 as well), and the block unit control processing 1 ends.

Here, in the image processing section 50 shown in FIG. 15, when a processing request is inputted from the workflow managing section 46A to an image processing module 384 of the final stage, the control section 38B of the image processing module 384 inputs a reading request to a buffer module 403 of the preceding stage (refer to (2) of FIG. 15). At this time, no effective data (image data) which can be read by the image processing module 384 is stored in the buffer 40A of the buffer module 403. Therefore, the buffer control section 40B of the buffer module 403 inputs a data request to the workflow managing section 46A (refer to (3) of FIG. 15).

Each time a data request is inputted from the buffer module 40, the workflow managing section 46A carries out the block unit control processing 2 shown in FIG. 14B. In this block unit control processing 2, in step 510, on the basis of the information registered in the table shown in FIG. 3B, the image processing module 38 of the preceding stage (here, an image processing module 383) of the buffer module 40 which is the source of input of the data request (here, the buffer module 403), is recognized, and a processing request is inputted to the recognized image processing module 38 of the preceding stage (refer to (4) of FIG. 15), and the processing ends.

When a processing request is inputted, the control section 38B of the image processing module 383 inputs a reading request to a buffer module 402 of the preceding stage (refer to (5) of FIG. 15). Because image data which can be read is also not stored in the buffer 40A of the buffer module 402, the buffer control section 40B of the buffer module 402 inputs a data request to the workflow managing section 46A (refer to (6) of FIG. 15). Also when a data request is inputted from the buffer module 402, the workflow managing section 46A again carries out the above-described block unit control processing 2, and thereby inputs a processing request to an image processing module 382 of the preceding stage (refer to (7) of FIG. 15). The control section 38B of the image processing module 382 inputs a reading request to a buffer module 40₁ of the preceding stage (refer to (8) of FIG. 15). Further, because image data which can be read is also not stored in the buffer 40A of the buffer module 40₁, the buffer control section 40B of the buffer module 40₁ also inputs a data request to the workflow managing section 46A (refer to (9) of FIG. 15). Also when a data request is inputted from the buffer module 40₁, the workflow managing section 46A again carries out the above-described block unit control processing 2, and thereby inputs a processing request to an image processing module 381 of the preceding stage (refer to (10) of FIG. 15).

Here, the module of the preceding stage of the image processing module 38₁ is the image data supplying section 22. Therefore, by inputting a data request to the image data supplying section 22, the control section 38B of the image processing module 38₁ acquires image data of the unit read data amount from the image data supplying section 22 (refer to (11) of FIG. 15). The image data, which is obtained by the image processing engine 38A carrying out image processing on the acquired image data, is written to the buffer 40A of the buffer module 40₁ of the following stage (refer to (12) of FIG. 15). Note that, when the control section 38B of the image processing module 381 finishes the writing of image data to the buffer 40A of the buffer module 40₁ of the following stage, the control section 38B inputs a processing completed notice to the workflow managing section 46A.

Each time a processing completed notice is inputted from the image processing module 38, the workflow managing section 46A carries out the block unit control processing 3 shown in FIG. 14C. In this block unit control processing 3, in step 520, it is judged whether or not the source of the processing completed notice is the image processing module 38 of the final stage of the image processing section 50. If the judgment is negative in this case, the routine moves on to step 524, and after the processing of step 524 through step 528 are carried out, the block unit control processing 3 ends (the same holds for cases in which a processing completed notice is inputted from the image processing module 382, 383). Note that the processing of step 524 through step 528 of the block unit control processing 3 will be described later.

Further, when effective data, which can be read by the image processing module 382 of the following stage and which is of an amount which is greater than or equal to the unit read data amount, is written, the buffer control section 40B of the buffer module 40₁ requests reading to the image processing module 382. Accompanying this, the control section 38B of the image processing module 382 reads image data of the unit read data amount from the buffer 40A of the buffer module 401 (refer to (13) of FIG. 15), and the image processing engine 38A carries out image processing on the acquired image data. The image data obtained thereby is written to the buffer 40A of the buffer module 402 of the following stage (refer to (14) of FIG. 15). When effective data, which can be read by the image processing module 383 of the following stage and which is of an amount which is greater than or equal to the unit read data amount, is written, the buffer control section 40B of the buffer module 402 requests reading to the image processing module 383. The control section 38B of the image processing module 383 reads image data of the unit read data amount from the buffer 40A of the buffer module 402 (refer to (15) of FIG. 15), and the image processing engine 38A carries out image processing on the acquired image data. The image data obtained thereby is written to the buffer 40A of the buffer module 403 of the following stage (refer to (16) of FIG. 15).

Further, when effective data, which can be read by the image processing module 384 of the following stage and which is of an amount which is greater than or equal to the unit read data amount, is written, the buffer control section 40B of the buffer module 403 requests reading to the image processing module 384. Accompanying this, the control section 38B of the image processing module 384 reads image data of the unit read data amount from the buffer 40A of the buffer module 403 (refer to (17) of FIG. 15), and the image processing engine 38A carries out image processing on the acquired image data. The image data obtained thereby is outputted to the image outputting section 24 which is the module of the following stage (refer to (18) of FIG. 15). Further, when the control section 38B of the image processing module 384 completes the writing of image data to the image outputting section 24 of the following stage, the control section 38B inputs a processing completed notice to the workflow managing section 46A (refer to (19) in FIG. 15). In this case, the judgment in step 520 of the aforementioned block unit control processing 3 is affirmative, and the routine proceeds to step 522 where a processing request is again inputted to the image processing module 384 which is the final-stage image processing module 38, and thereafter, processing ends.

Due to a processing request being re-inputted to the image processing module 384 which is the final stage, the above-described processing sequence is repeated again, and image processing, which is in a form of execution of block units, is successively carried out on the image data which is the object of processing. When the image data supplied from the image data supplying section 22 reaches the end of the image data which is the object of processing, input of entire processing ended notices from the individual image processing modules 38 to the workflow managing section 46A is successively carried out from the image processing module 38 at the preceding stage side.

Each time an entire processing ended notice is inputted from the image processing module 38, the workflow managing section 46A carries out the block unit control processing 4 shown in FIG. 14D. In this block unit control processing 4, in step 540, it is judged whether or not the image processing module 38, which is the source of input of the entire processing ended notice, is the image processing module 38 of the final stage. If this judgment is negative, processing ends without any processing being carried out. In a case in which an entire processing ended notice is inputted from the image processing module 38 of the final stage due to all of the image data, which is obtained by the necessary image processing being carried out on the image data which is the object of processing, being outputted to the image outputting section 24, the judgment of step 540 is affirmative, and the routine moves on to step 542. In step 542, the application 32 is notified of the completion of image processing (refer to step 180 of FIGS. 2A and 2B as well), and the block unit control processing ends. Then, the application 32, which has been notified of the completion of image processing, notifies the user that image processing has been completed (refer to step 182 in FIGS. 2A and 2B as well).

In this way, in the block unit processing, a processing request inputted to the image processing module 38 of the final stage is transferred backward to the image processing modules 38 of the preceding stages. When the processing request reaches the image processing module 38 of the preceding-most stage, a series of image processing is carried out by a flow in which image processing is carried out at the image processing module 38 of the preceding-most stage, data is written to the buffer module 40 of the following stage, and if the data suffices, the processing proceeds to the module of the following stage.

Note that the processing sequence in the block unit processing is not limited to that described above, and may be structured such that, each time a data request is inputted from the buffer module 40, instead of inputting a processing request to the buffer module 40 which is the source of input of the data request, first, processing requests are inputted respectively to all of the image processing modules 38 in block unit control processing 1, and, during the period of time until an entire processing completed notice is inputted from a specific image processing module, each time a processing completed notice is inputted from a specific image processing module 38, the processing of re-inputting the processing request to the specific image processing module 38 which is the source of input of the processing completed notice is carried out respectively for all of the image processing modules.

The image processing section relating to the exemplary embodiments of the present invention is constructed by connecting the image processing modules 38 and the buffer modules 40 in the form of a pipeline or in the form of a directed acyclic graph. At the individual image processing modules 38, if image data of an amount greater than or equal to the unit read data amount is not accumulated at the buffer module 40 connected at the preceding stage, the image processing module 38 cannot start the image processing at its own module (except for the preceding-most image processing module 38 which is connected to the image data supplying section 22). Therefore, the progress of the image processing at the individual image processing module 38 depends on the states of progress of the image processing at the image processing modules 38 which are positioned at more preceding stages. The processing efficiency improves by prioritarily executing the image processing at the image processing module which is positioned at the preceding stage side in the pipeline form or the directed acyclic graph form among the respective image processing modules, in particular at the time of the start of execution of a series of image processing at the image processing section or at a time period in a vicinity thereof.

Further, in a structure in which the image processing modules 38 and the buffer modules 40 are connected in a pipeline form or a directed acyclic graph form, the progress of the image processing at the image processing module 38 of a following stage side is always after that of the image processing module 38 of the preceding stage side, and the remaining amount of the image data which is the object of processing also is always greater at the image processing module 38 of the following stage side. Therefore, as the series of image processing progresses at the image processing section, the processing efficiency is improved more if the execution priority level of the image processing at the image processing module positioned at the following stage side is made to be higher. In particular, at the time when execution of the series of image processing at the image processing section ends or at a time period in the vicinity thereof, as the number of image processing modules 38 at which entire processing has been completed gradually increases from the preceding stage side, it is preferable, from the standpoint of processing efficiency, to make even higher the execution priority level of the image processing at the image processing module positioned at the following stage side.

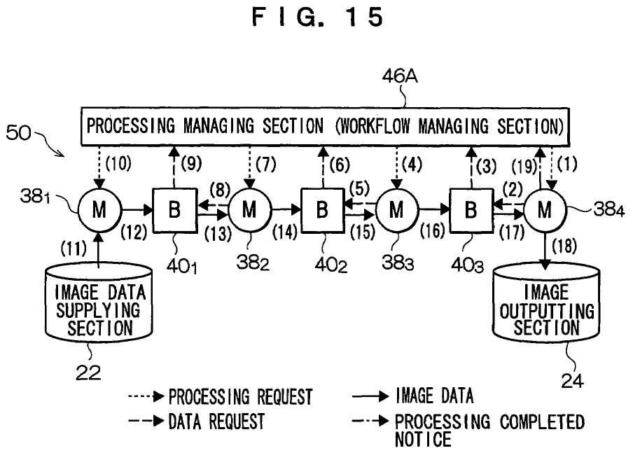

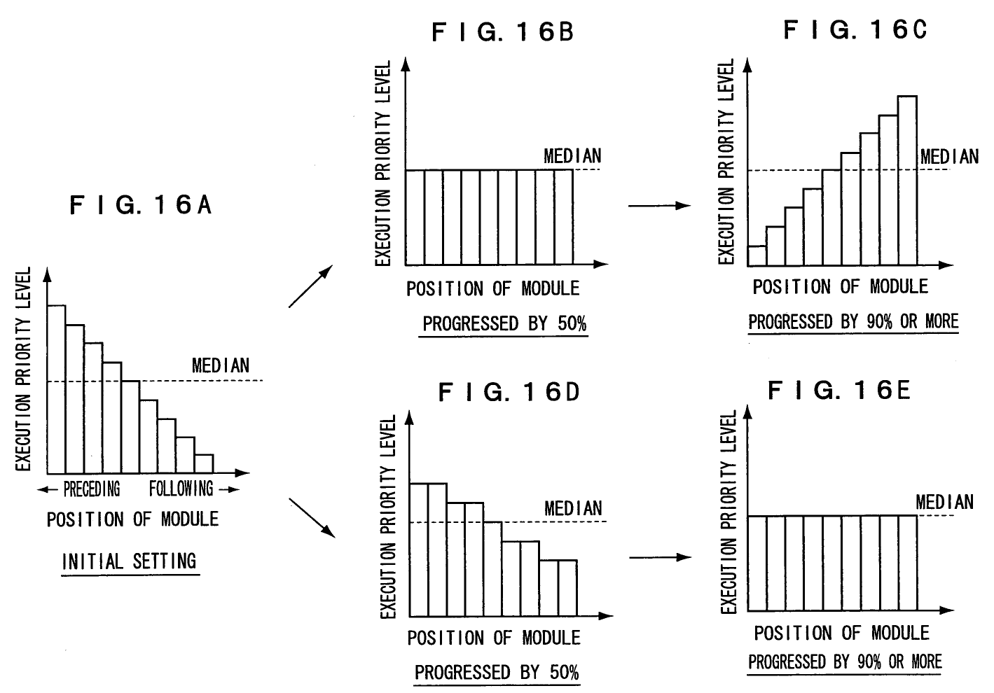

On the basis of the above, in step 502 of the block unit control processing 1 (see FIG. 14A) which is executed at the time when the workflow managing section 46A relating to the first exemplary embodiment is started-up by the application 32, the workflow managing section 46A carries out initial setting of the execution priority levels of the individual threads which execute the programs of the individual image processing modules 38, such that the execution priority levels of the individual threads become higher the closer that the position of the image processing module 38 is to the preceding stage side in the connected form which is the pipeline form or the directed acyclic graph form, as shown as an example in FIG. 16A.

If the image processing section is in a pipeline form for example, the aforementioned “position of the image processing module 38” can be judged on the basis of the position value which is assigned in ascending order from the head (preceding-most) image processing module 38 as shown in FIG. 17A (or the position value which is assigned in descending order from the final (following-most) image processing module 38). If the image processing section is in a directed acyclic graph form, as shown in FIG. 17B, position values are assigned in ascending order from the head (preceding-most) image processing module 38 (or in descending order from the final (following-most) image processing module 38), and for the image processing module 38 (image processing module E in the example of FIG. 17B) which acquires image data from plural image processing modules via buffer modules, a position value is assigned on the basis of the maximum value (or the minimum value) of the position values assigned to the plural image processing modules of the preceding stage, and the aforementioned “position of the image processing module 38” can be judged on the basis of this position value.

Further, making the execution priority level of the corresponding thread to be higher the nearer the position of the image processing module 38 is to the preceding stage side in the connected form which is a pipeline form or a directed acyclic graph form, can be achieved by, for example, if the execution priority levels which can be set at the threads corresponding to the image processing modules are nine levels of 1 through 9 and position values are assigned to the individual image processing modules 38 in ascending order with the initial value being 1 from the preceding stage side, setting the execution priority levels of the threads corresponding to the individual image processing modules 38 such that:

execution priority level=10−(position value)

(where the execution priority level=1 if the execution priority level<1).
Or, the execution priority levels may be set by using a specific monotone decreasing function (e.g., a function in which the execution priority level decreases linearly with respect to an increase in the position value) which is such that, when the position value is the minimum value, the execution priority level is set to “9”, and when the position value is the maximum value, the execution priority level is set to “1”. In this way, at the point in time when the series of image processing is started at the image processing section, the closer that the position of the corresponding image processing module 38 of a thread is to the preceding stage side in the connected form which is a pipeline form or a directed acyclic graph form, the higher the execution priority level at which that thread is executed by the CPU 12, and image processing can be carried out at a high processing efficiency by utilizing the CPU 12 effectively.

Further, in the block unit control processing 3 (see FIG. 14C) which the workflow managing section 46A relating to the first exemplary embodiment executes each time a processing completed notice is inputted from the image processing module 38, in step 524, the workflow managing section 46A judges the extent of progress of the image processing of the overall image processing section. This judgment can be carried out as follows for example: the individual image processing modules 38 are structured such that, at the time when processing completed notices are transmitted to the workflow managing section 46A from the individual image processing modules 38, progress extent information, which enables judgment of the extent of progress of the image processing at the image processing module 38, is transmitted together therewith, and each time the workflow managing section 46A receives the processing completed notice from the image processing module 38, the workflow managing section 46A holds the progress extent information which is received simultaneously therewith (if progress extent information which was received previously from the same image processing module 38 is already held, the already-held progress extent information is overwritten by the newly-received progress extent information), and thereafter, the workflow managing section 46A calculates the total extent of progress of the image processing of the overall image processing section from the progress extent information corresponding to the individual image processing modules 38.

It is preferable that the progress extent information be information whose burden on (the CPU 12 executing the thread corresponding to) the image processing module 38 during derivation is as small as possible. For example, it is possible to use information which expresses the proportion of the image data which has been processed of the image processing module 38 with respect to the entire image data which is the object of processing (specifically, the proportion of the data amount or the proportion of the number of lines or the like). Further, it is also possible for information expressing the data amount or the number of lines of the image data which has been processed to be transmitted from each image processing module 38 as the progress extent information, and the extent of progress (the aforementioned proportion or the like) of the image processing at each image processing module 38 to be computed at the workflow managing section 46A.

In next step 526, it is judged whether or not the extent of progress of the image processing of the overall image processing section which was judged in step 524 is a value such that the execution priority levels of the threads corresponding to the individual processing modules 38 should be changed. Note that there is no need to frequently change the execution priority levels of the threads, and, in order to avoid placing an excessive burden on the CPU 12 by frequently carrying out changing of the execution priority levels, it is good to use, as the judgment condition in the judgment of step 526, a judgment condition which is such that the execution priority levels of the threads are changed at an interval which is sparse to the extent that no excessive burden arises, such as, for example, the aforementioned judgment is affirmative each time that the extent of progress of the image processing has increased by 10% from the last time that changing of the execution priority levels of the threads (or the initial setting) was carried out, or the like.

If the above judgment is negative, the block unit control processing 3 ends without any processing being carried out. However, if this judgment is affirmative, in step 528, the execution priority levels of the threads corresponding to the individual image processing modules 38 are changed and set, by using the median (or the average value) of the execution priority levels which were set for the respective threads at the time of initial setting as a reference, such that, for a thread whose execution priority level was set to be high at the time of initial setting, the execution priority level thereof gradually decreases as image processing progresses, and for a thread whose execution priority level was set to be low at the time of initial setting, the execution priority level thereof gradually increases as image processing progresses. Thereafter, the block unit control processing 3 ends.

Note that the changing of the execution priority levels in step 528 may be carried out by making the amount of change in the execution priority level of the corresponding thread greater the nearer the position of the image processing module 38 is to the preceding-most stage or the following-most stage, such as, as shown in FIGS. 16B and 16C for example, near the end of the image processing of the image processing section overall, inverting the large/small relationship of the execution priority levels of threads corresponding to the image processing modules 38 of the preceding stage side and the execution priority levels of the threads corresponding to the image processing modules 38 of the following stage side. Or, the changing of the execution priority levels in step 528 may be carried out by, as shown in FIGS. 16D and 16E for example, near the end of the image processing of the image processing section overall, making the execution priority levels of the threads corresponding to the respective image processing modules 38 be uniform. By changing as described above the execution priority levels of the threads corresponding to the individual image processing modules 38 as the series of image processing progresses at the image processing section, the CPU 12 can be utilized effectively and image processing can be carried out at a high processing efficiency.

Note that the initial setting and the changing of the execution priority levels of the threads corresponding to the individual image processing modules 38 as described above is processing corresponding to the priority level controlling component of the present invention. In the first exemplary embodiment, the (CPU 12 executing the program of the) workflow managing section 46A also functions as the priority level controlling component of the present invention.

Further, in the above description, the inputting of the processing request to the image processing module 38 of the final stage is carried out by the workflow managing section 46A. However, the present invention is not limited to the same. The workflow managing section 46A may hold the module(s) positioned at the final stage of a pipeline or at plural final points of a directed acyclic graph and carry out the processing request, or the application 32 may hold the module(s) and carry out the processing request. Or, as in the example of above-described FIG. 4B, in a case in which, at the interior of the module generating section 44, an image processing module which carries out skew angle sensing processing and an image processing module which carries out image rotating processing are combined so as to form a skew correcting processing module, the skew angle information is needed as a processing parameter at the time of generating the image rotating processing module. Thus, there is also the method in which, at the interior of the skew correcting module generating section, a processing request is repeatedly made to the skew angle sensing processing module, and the entire image is processed, and the skew angle information obtained as a result thereof is provided to the image rotating processing module as a processing parameter.

Next, description will be given of the deleting of the image processing section 50, which is carried out after image processing on the image data which is the object of processing has been completed. In step 308 of the image processing module control processing (FIGS. 12A and 12B), the control section 38B of the individual image processing module 38 outputs an entire processing ended notice to the workflow managing section 46A and to the module of the following stage, and thereafter, in step 310, carries out self-module deletion processing. In the self-module deletion processing, the memory region reserved in previous step 254 (FIGS. 11A and 11B) is freed by the resource managing section 46B, and if there is a resource, other than the memory, which its own module reserved through the resource managing section 46B, that resource is freed by the resource managing section 46B, and the control section 38B inputs a deletion notice, for giving notice that processing for deleting its own module is to be carried out, to the module of the preceding stage of its own module, the module of the following stage of its own module, and the workflow managing section 46A, and thereafter, the processing of deleting its own module is carried out. Note that deleting of its own module can be realized by either ending the thread (or process) corresponding to its own module, or deleting the object.

Note that, in the buffer control processing (FIGS. 5A and 5B) carried out by the buffer control section 40B of the buffer module 40, when a deletion notice is inputted from the image processing module 38 of the preceding stage or the following stage of its own module, the judgment in step 380 is affirmative, and the routine moves on to step 390. In step 390, after the module which is the source of input of the deletion notice is stored, it is judged whether or not deletion notices have been inputted from all of the modules of the preceding stage and the following stage of its own module. If the judgment is negative, the routine returns to step 378, and steps 378 and 380 are repeated as described above. Further, when deletion notices are inputted from all of the modules of the preceding stage and the following stage of its own module, the judgment in step 390 is affirmative, and the routine proceeds to step 392. In step 392, by inputting a deletion notice to the workflow managing section 46A, the buffer control section 40B gives notice that the processing of deleting its own module is to be carried out. Then, in next step 394, processing for deleting its own module is carried out, and the buffer control processing (FIGS. 5A and 5B) ends.

In the above-described first exemplary embodiment, the extent of progress of the image processing of the overall image processing section is judged each time a processing completed notice is received from the image processing module 38, but the present invention is not limited to the same. The extent of progress of the image processing may be judged each time a given period of time elapses, regardless of the receipt of a processing completed notice from an image processing module, and the changing and setting of the execution priority levels of the threads corresponding to the respective image processing modules 38 may be carried out as needed.

### Second Exemplary Embodiment

A second exemplary embodiment of the present invention will be described next. Note that, because the second exemplary embodiment has the same structure as the first exemplary embodiment, the respective portions are denoted by the same reference numerals and description of the structures is omitted. Hereinafter, with regard to the block unit control processing by the workflow managing section 46A (the initial setting of and the changing of the execution priority levels of the threads corresponding to the respective image processing modules 38), only the portions thereof which differ from the first exemplary embodiment will be described as the operation of the second exemplary embodiment.

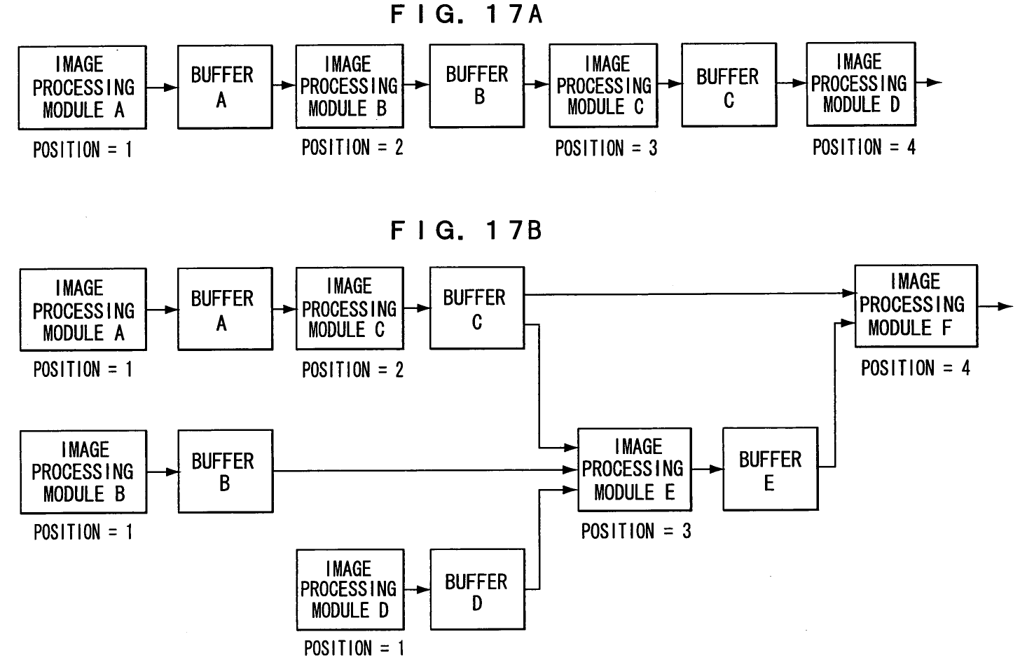

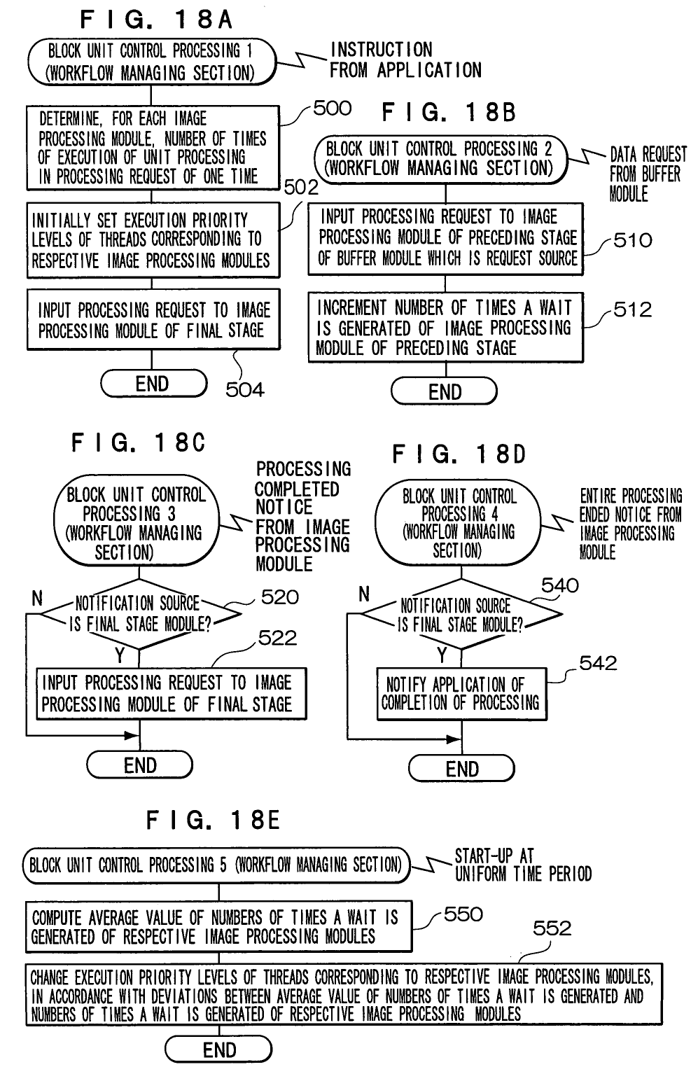

In step 502 of the block unit control processing 1 (see FIG. 18A) which is executed at the time when the workflow managing section 46A relating to the second exemplary embodiment is started-up by the application 32, the workflow managing section 46A carries out initial setting of the execution priority levels of the individual threads which execute the programs of the individual image processing modules 38, such that the execution priority levels of the individual threads become higher the closer that the position of the image processing module 38 is to the preceding stage side in the connected form which is the pipeline form or the directed acyclic graph form, in the same way as in the first exemplary embodiment.

For the individual image processing modules 38, the workflow managing section 46A relating to the second exemplary embodiment holds, as a number of times a wait is generated, the number of times (this number of times corresponds to the “number of times of image data acquisition has failed” of the present invention) that, although a read request was inputted to the buffer module 40 of the following stage from the image processing module 38 connected to the following stage via that buffer module 40 of the following stage (i.e., the image processing module 38 whose position value is equal to the position value of the present module plus 1), because the effective data stored in that buffer module 40 of the following stage is less than the unit read data amount, a data request is inputted from that buffer module 40 of the following stage, and a “wait” (a standby state until the effective data of the buffer module 40 becomes greater than or equal to the unit read data amount) is generated at the image processing module of the following stage. (The initial value of the number of times a wait is generated of each image processing module 38 is 0.) Then, in the block unit control processing 2 (see FIG. 18B) which is executed each time that a data request is inputted from an arbitrary buffer module 40, in step 510, the workflow managing section 46A inputs a processing request to the image processing module 38 of the preceding stage of the buffer module 40 which is the source of input of the data request. Thereafter, in next step 512, the number of times a wait is generated of the image processing module 38 of the preceding stage of the buffer module 40 which is the source of input of the data request, is incremented by 1, and processing ends.

Further, in block unit control processing 3 which the workflow managing section 46A relating to the second exemplary embodiment executes each time it receives a processing completed notice from the image processing module 38, the workflow managing section 46A does not carry out judging of the extent of progress of the image processing and changing of the execution priority levels of the threads corresponding to the respective image processing modules 38 as in the first exemplary embodiment (refer to FIG. 14C, steps 524 through 528), but on the other hand, executes block unit control processing 5 shown in FIG. 18E at a given time period.

In this block unit control processing 5, first, in step 550, the workflow managing section 46A fetches the numbers of times a wait is generated which are held for the respective image processing modules 38, and computes the average value of the fetched numbers of times a wait is generated of the respective image processing modules 38. Then, in step 552, the workflow managing section 46A changes the execution priority levels of the threads corresponding to the respective image processing modules 38, in accordance with the average value of the numbers of times a wait is generated which was computed in step 550, and the deviations of the numbers of times a wait is generated of the individual image processing modules 38. The changing of the execution priority levels in step 552 can be carried out by, for the image processing module 38 whose number of times a wait is generated is greater than the average value, the greater the aforementioned deviation, the more the execution priority level of the corresponding thread is increased, and for the image processing module 38 whose number of times a wait is generated is smaller than the average value, the greater the aforementioned deviation, the more the execution priority level of the corresponding thread is decreased. Specifically, the changing of the execution priority levels can be carried out in accordance with the following formulas for example.

rate of change (%) in execution priority level=(number of times a wait is generated−average value of numbers of times a wait is generated)/average value×100 execution priority level after change=execution priority level+(execution priority level×rate of change)/100

### Note that, when carrying out the above-described computation, the median of the numbers of times a wait is generated may be used instead of the average value of the numbers of times a wait is generated.

The image processing module 38, whose number of times a wait is generated is greater than the average value, causes a relative large number of times of “waits” to be generated at the image processing module 38 connected to the following stage via the buffer module 40 of the following stage, and it can be judged that the image processing at that image processing module 38 is a bottleneck of the image processing of the entire image processing section. In step 552, the execution priority level of the thread corresponding to such an image processing module 38 is increased. Further, for the image processing module 38, whose number of times a wait is generated is lower than the average value, the number of times a “wait” is generated at the image processing module 38 connected to the following stage via the buffer module 40 of the following stage is relatively low. Therefore, the image processing of the image processing section overall can be made to be more efficient by prioritizing the image processing at another image processing module 38 whose number of times a wait is generated is relatively large as compared to that image processing module 38. In step 552, the execution priority level of the thread corresponding to such an image processing module 38 is decreased.

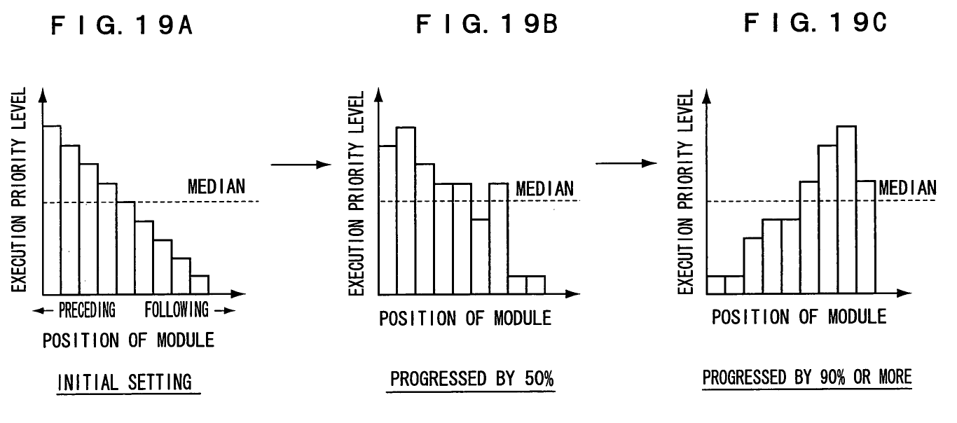

In the second exemplary embodiment, by executing the above-described block unit control processing 5 at a given time interval, the execution priority levels of the threads corresponding to the individual image processing modules 38 are optimized in accordance with the number of times a wait is generated at the image processing module 38 of the following stage (the deviation between the number of times a wait is generated at the image processing module 38 of the following stage and the average value of the numbers of times a wait is generated) as shown as an example in FIG. 19, and the CPU 12 can be utilized effectively and image processing can be carried out at a high processing efficiency. Note that the initial setting and the changing of the execution priority levels of the threads corresponding to the individual image processing modules 38 as described above is processing corresponding to the priority level controlling component of the present invention. In the second exemplary embodiment, the (CPU 12 which executes the programs of the) workflow managing section 46A also functions as the priority level controlling component of the present invention.

Note that, in the second exemplary embodiment, the number of times that a data request is inputted from the buffer module 40 of the following stage, i.e., the number of times a “wait” is generated at the image processing module 38 which is connected to the following stage via the buffer module 40 of the following stage, is used as the number of times a wait is generated at the individual image processing modules 38. However, as the number of times a wait is generated, it is possible to use a number of times which is the sum of that number of times and the number of times that, although the image processing module 38 wrote image data to the buffer module 40 of the following stage, the effective data of the buffer module 40 of the following stage did not reach the unit read data amount of the image processing module 38 of the following stage. This case is preferable because the number of times a wait is generated is a value which more accurately reflects the proportion of “waits” at the image processing module 38 of the following stage.

Further, in the second exemplary embodiment, the execution priority levels of the threads corresponding to the respective image processing modules 38 are changed on the basis of the “number of times a wait is generated” as described above. Therefore, even if the initial setting of the execution priority levels in step 502 of the block unit control processing 1 (see FIG. 18A) is omitted, by repeating the block unit control processing 5 several times, the execution priority levels of the threads corresponding to the respective image processing modules 38 at the initial time period at the start of the image processing at the image processing section can be optimized so as to become higher the closer that the position of the image processing module 38 is to the preceding stage side in the connected form which is the pipeline form or the directed acyclic graph form, as shown in FIG. 16A. Accordingly, in the second exemplary embodiment, the initial setting of the execution priority levels in step 502 of the block unit control processing 1 (see FIG. 18A) may be omitted. However, in a case in which the initial setting of the execution priority levels is carried out, the execution priority levels of the threads corresponding to the individual image processing modules 38 are already optimized at the point in time of the start of image processing at the image processing section, and therefore, the processing efficiency can be improved over a case in which initial setting of the execution priority levels is omitted.

Moreover, in the second exemplary embodiment, the execution priority levels of the threads corresponding to the individual image processing modules 38 are changed in accordance with the number of times a “wait” is generated at the image processing module 38 of the following stage which is connected via the buffer module 40 of the following stage. However, in addition thereto, the execution priority levels of the threads may be changed in accordance with the number of times a “wait” is generated at its own module (specifically, for a thread corresponding to an image processing module 38 whose number of times a wait is generated is relatively large, the execution priority level thereof may be lowered, and for a thread corresponding to an image processing module 38 whose number of times a wait is generated is relatively small, the execution priority level thereof may be raised).

### Third Exemplary Embodiment

A third exemplary embodiment of the present invention will be described next. Note that, because the third exemplary embodiment has the same structure as the first exemplary embodiment, the respective portions are denoted by the same reference numerals and description of the structures is omitted. Hereinafter, with regard to the block unit control processing by the workflow managing section 46A (the initial setting and the changing of the execution priority levels of the threads corresponding to the respective image processing modules 38), only the portions thereof which differ from the second exemplary embodiment will be described as the operation of the third exemplary embodiment.

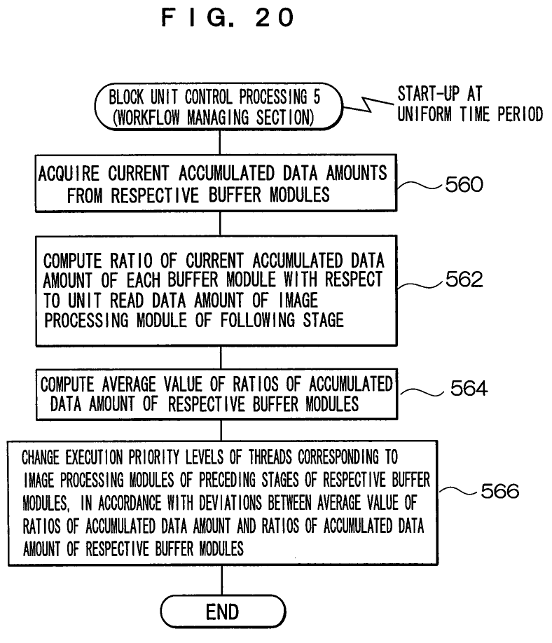

Instead of the block unit control processing 5 (see FIG. 18E) described in the second exemplary embodiment, the workflow managing section 46A relating to the third exemplary embodiment carries out, at a uniform time period, the block unit control processing 5 shown in FIG. 20. In this block unit control processing 5, first, in step 560, the workflow managing section 46A acquires the current accumulated data amount of each buffer module 40, by inquiring each buffer module 40 as to its current accumulated data amount (data amount of effective data). Note that the accumulated data amount may be a value expressed by a number of bytes, or may be a value expressed by a number of lines of the image. In step 562, for each buffer module 40, the workflow managing section 46A computes the ratio of the current accumulated data amount of the buffer module 40 with respect to the unit read data amount of the image processing module 38 of the following stage thereof. For example, if the accumulated data amount is a value expressed by a number of lines of the image, and the accumulated data amount at a given buffer module 40 is “10 lines”, and the unit read data amount of the image processing module 38 of the following stage of that buffer module 40 is “1 line”, the ratio of the accumulated data amount is 10/1=10. If the unit read data amount of the image processing module 38 of the following stage is “8 lines”, the ratio of the accumulated data amount is 10/8=1.25.

In next step 564, the workflow managing section 46A computes the average value of the ratios of the accumulated data amount computed for the respective buffer modules 40 in step 562. Then, in step 566, the workflow managing section 46A changes the execution priority levels of the threads corresponding to the respective image processing modules 38 of the preceding stages of the individual buffer modules 40, in accordance with the deviations between the average value of the ratios of the accumulated data amount computed in step 564 and the ratios of the accumulated data amount of the individual buffer modules 40. The changing of the execution priority levels in step 566 can be carried out such that, for the image processing module 38 of the preceding stage of the buffer module 40 whose ratio of the accumulated data amount is lower than the average value, the greater the above deviation, the more the execution priority level of the corresponding thread is increased. Specifically, the changing of the execution priority levels can be carried out in accordance with the following formulas for example.

rate of change (%) in execution priority level=(average value−ratio of accumulated data amount)/average value×100

execution priority level after change=original execution priority level+(execution priority level×rate of change)/100

### Note that, when carrying out the above-described computation, the median of the ratios of the accumulated data amount may be used instead of the average value of the ratios of the accumulated data amount.

For a buffer module 40 whose ratio of the accumulated data amount is lower than the average value, the data amount of the effective data is meager as compared with the unit read data amount at the image processing module 38 of the following stage, and the possibility that “waits” will be generated a relatively large number of times at the image processing module 38 of the following stage is high, and the possibility that the image processing at the image processing module 38 of the preceding stage of that buffer module will become a bottleneck in the image processing of the entire image processing section is high. However, in step 566, the execution priority level of the thread corresponding to such an image processing module 38 is increased. Further, at a buffer module 40 whose ratio of the accumulated data amount is higher than the average value, effective data of a data amount which is sufficient as compared with the unit read data amount at the image processing module 38 of the following stage is stored. Therefore, the image processing of the image processing section overall can be made to be more efficient by prioritizing, over the image processing at the image processing module 38 of the preceding stage of that buffer module, the image processing at the image processing module 38 at the preceding stage of another buffer module 40 whose ratio of the accumulated data amount is relatively small. In step 566, the execution priority level of the thread corresponding to such an image processing module 38 is decreased.

In the third exemplary embodiment, by executing the above-described block unit control processing 5 at a given time interval, the execution priority levels of the threads corresponding to the individual image processing modules 38 are optimized in accordance with the (deviation between the average value of the ratios of the accumulated data amount and the) ratio of the accumulated data amount at the buffer module 40 of the following stage as shown as an example in FIG. 19, and the CPU 12 can be utilized effectively and image processing can be carried out at a high processing efficiency. Note that the initial setting and the changing of the execution priority levels of the threads corresponding to the individual image processing modules 38 as described above is processing corresponding to the priority level controlling component of the present invention. In the third exemplary embodiment, the (CPU 12 which executes the programs of the) workflow managing section 46A also functions as the priority level controlling component of the present invention.

Further, in the third exemplary embodiment as well, in the same way as in the second exemplary embodiment, the initial setting of the execution priority levels may be omitted, but carrying out initial setting of the execution priority levels is preferable because the processing efficiency can be improved.

### Fourth Exemplary Embodiment

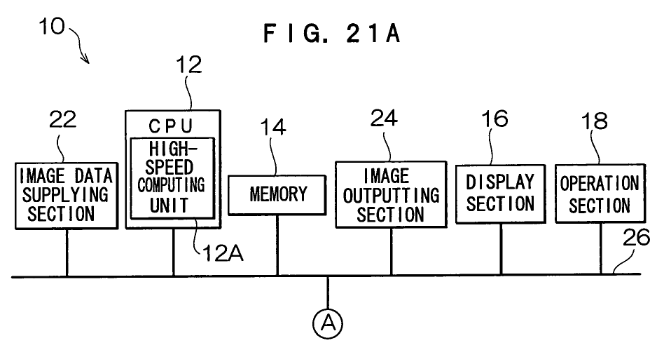

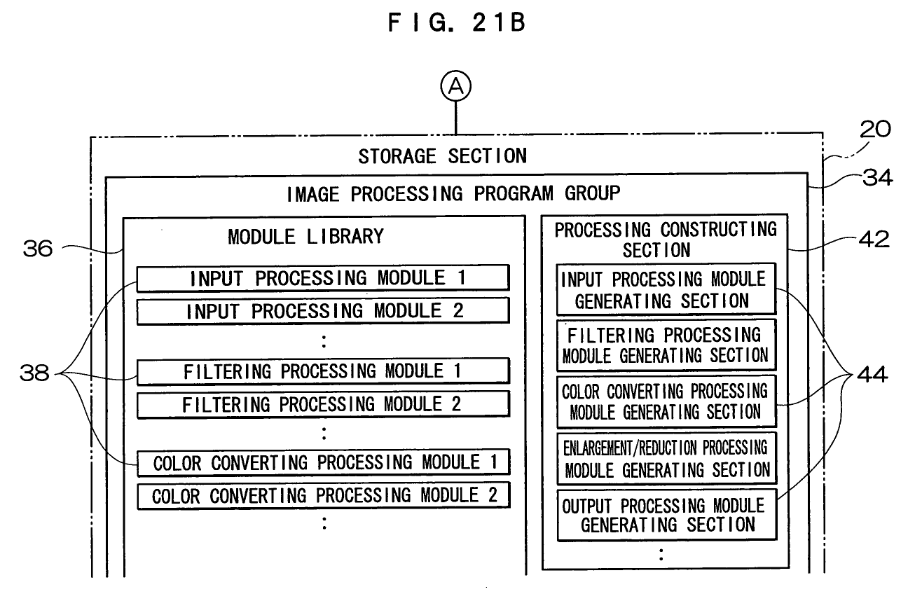

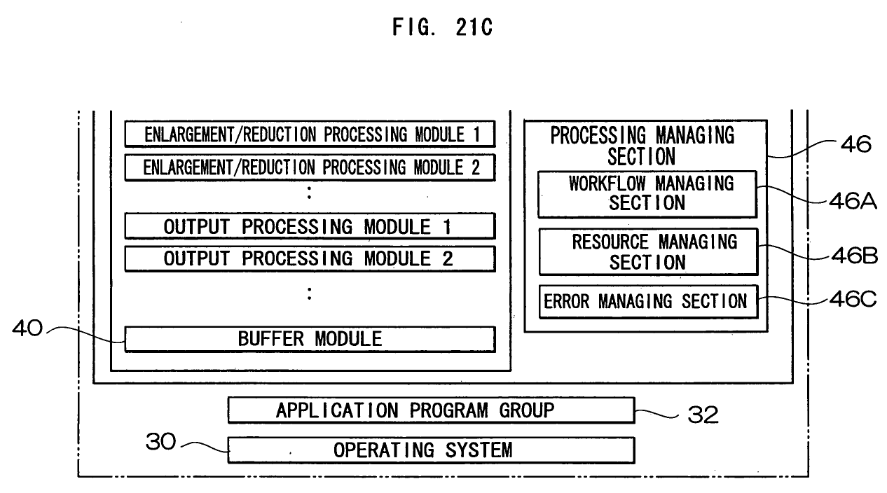

A fourth exemplary embodiment of the present invention will be described next. In the fourth exemplary embodiment, portions which are the same as in the first exemplary embodiment are denoted by the same reference numerals and description thereof is omitted. As shown in FIGS. 21A through 21C, a high-speed computing unit 12A, which is formed from a computing unit for MMX or a computing unit for SSE or the like, is provided at the CPU 12 of the computer 10 relating to the fourth exemplary embodiment. The high-speed computing unit 12A corresponds to the high-speed computing unit relating to the present invention. Note that the high-speed computing unit relating to the present invention is not limited to a high-speed computing unit provided at the CPU as described above. For example, another computing unit such as a DSP or the like which is provided separately from the CPU 12 can be used as the high-speed computing unit relating to the present invention.

Further, in the first through third exemplary embodiments, only programs for execution at the CPU 12 are stored, as programs for realizing the individual image processing modules, in the module library 36 which is stored in the storage section 20. However, first programs for execution at the CPU 12 and second programs for execution at the high-speed computing unit 12A are respectively stored, as programs for realizing the individual image processing modules, in the module library 36 which is stored in the storage section 20 relating to the fourth exemplary embodiment. At the time of generating the corresponding image processing module 38, the module generating section 44 respectively generates a CPU thread, which executes the first program of the corresponding image processing module 38 by the CPU 12, and a high-speed computing unit thread, which executes the second program of the corresponding image processing module 38 by the high-speed computing unit 12A. Note that the CPU thread and the high-speed computing unit thread which correspond to the same image processing module 38 are structured by using a known technique such as mutex (MUTual EXclusion service) or the like which can be used in exclusive control, so that they are executed exclusively (are not executed simultaneously).

Hereinafter, with regard to the block unit control processing by the workflow managing section 46A, only the portions thereof which differ from the first exemplary embodiment will be described as the operation of the fourth exemplary embodiment.

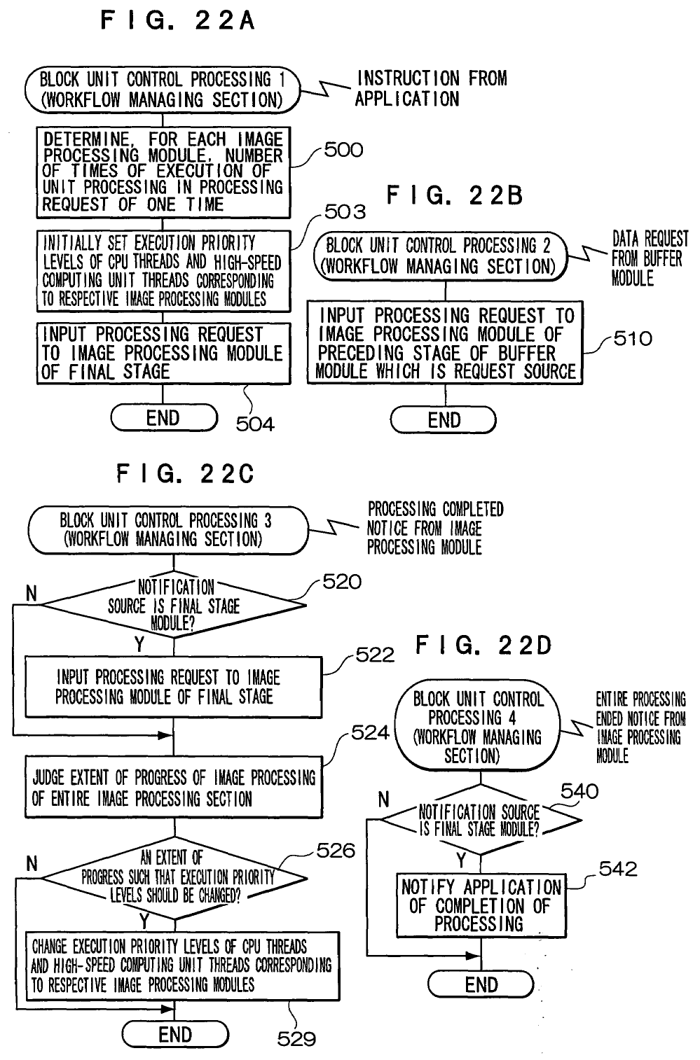

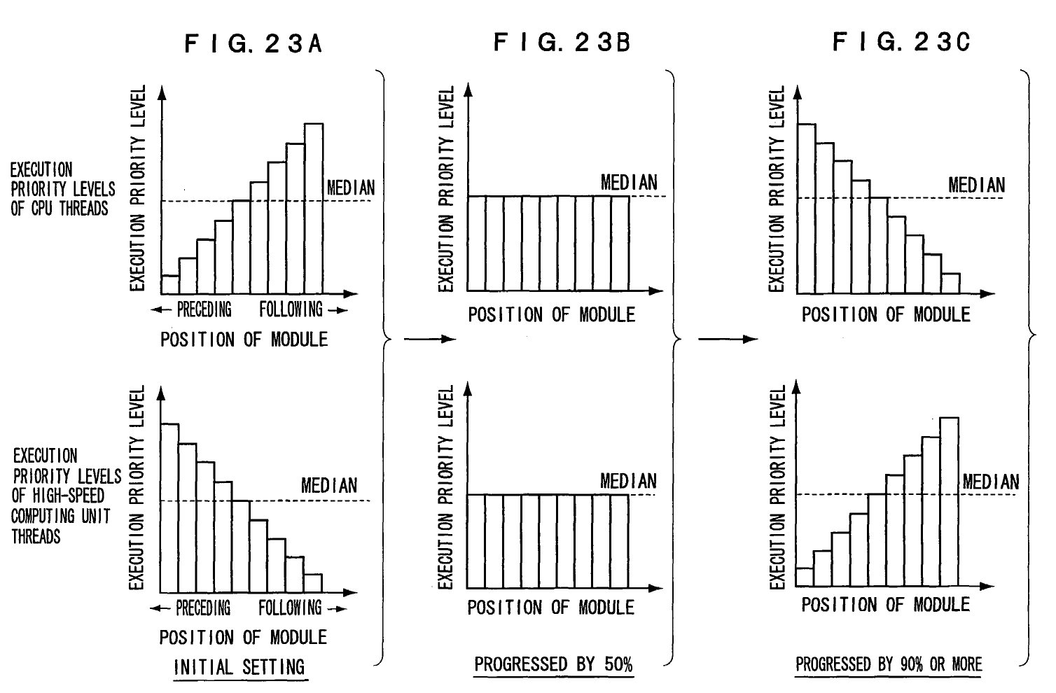

In the block unit control processing 1 which is executed at the time when the workflow managing section 46A relating to the fourth exemplary embodiment is started-up by the application 32, instead of step 502 (see FIG. 14A) described in the first exemplary embodiment, the workflow managing section 46A carries out initial setting of the execution priority levels of the CPU threads and the high-speed computing unit threads corresponding to the individual image processing modules 38 in step 503 as shown in FIG. 22A. In the initial setting of the execution priority levels in step 503, the execution priority levels of the CPU threads and the high-speed computing unit threads of the individual image processing modules 38 are set, as shown in FIG. 23A as an example, such that the nearer the position of the image processing module 38 is to the preceding stage side in the connected form which is the pipeline form or the directed acyclic graph form, the lower the execution priority level of the CPU thread and the higher the execution priority level of the high-speed computing unit thread (i.e., such that “the ratio of the execution priority level of the second program with respect to the execution priority level of the first program” of the present invention becomes higher).

Note that, because the CPU thread and the high-speed computing unit thread are executed exclusively as described above, in step 503, setting is carried out such that, for the image processing module 38 whose execution priority level of the high-speed computing unit thread is set to be a predetermined level higher than the median, the execution priority level of the CPU thread is a predetermined level lower than the median, whereas for the image processing module 38 whose execution priority level of the CPU thread is set to be a predetermined level higher than the median, the execution priority level of the high-speed computing unit thread is a predetermined level lower than the median. In this way, at the point in time when the series of image processing is started at the image processing section, the closer the position of the corresponding image processing module 38 is to the preceding stage side in the connected form which is a pipeline form or a directed acyclic graph form, the higher the efficiency with which the high-speed computing unit thread among the corresponding threads is executed at the high-speed computing unit 12A. Image processing can be carried out at a high processing efficiency by utilizing the high-speed computing unit 12A more effectively than the CPU 12.

Further, in the block unit control processing 3 which the workflow managing section 46A relating to the fourth exemplary embodiment executes each time a processing completed notice is inputted from the image processing module 38, if it is judged that the time at which the execution priority levels should be changed has arrived (i.e., if the judgment in step 526 is affirmative), as shown in FIG. 22C, in step 529, the workflow managing section 46A changes the execution priority levels of the CPU threads and the high-speed computing unit threads corresponding to the individual image processing modules 38, instead of step 528 (see FIG. 14C) described in the first exemplary embodiment. As shown in FIGS. 23B and 23C, the changing of the execution priority levels in step 528 can be carried out such that, by using as a reference the medians (or the average values) of the execution priority levels set for the respective threads at the time of initial setting, for the image processing module 38 at which a high execution priority level is set for the high-speed computing unit thread at the time of initial setting, as the image processing progresses, the execution priority level of the high-speed computing unit thread gradually decreases and the execution priority level of the CPU thread gradually increases, and, for the image processing module 38 at which a low execution priority level is set for the high-speed computing unit thread at the time of initial setting, as the image processing progresses, the execution priority level of the high-speed computing unit thread gradually increases and the execution priority level of the CPU thread gradually decreases.

By changing the execution priority levels of the high-speed computing unit threads and the CPU threads corresponding to the individual image processing modules 38 as described above as the series of image processing at the image processing section progresses, the high-speed computing unit 12A (and the CPU 12) are utilized effectively, and image processing can be carried out at a high processing efficiency. Note that the initial setting and the changing of the execution priority levels of the high-speed computing unit threads and the CPU threads corresponding to the individual image processing modules 38 as described above is processing corresponding to the priority level controlling component of the present invention. In the fourth exemplary embodiment, the (CPU 12 which executes the programs of the) workflow managing section 46A also functions as the priority level controlling component of the present invention.

Note that, in the fourth exemplary embodiment, the changing of the execution priority levels of the high-speed computing unit threads and the CPU threads is not limited to, near the end of the image processing of the image processing section overall, reversing the large/small relationship of the execution priority levels of the high-speed computing unit threads and the CPU threads corresponding to the individual image processing modules 38 from that at the time of the initial setting, as shown in FIGS. 23B and 23C. The changing of the execution priority levels may be carried out such that, near the end of the image processing of the image processing section overall, the execution priority levels of the high-speed computing unit threads and the CPU threads corresponding to the individual image processing modules 38 become uniform in the same way as in FIG. 16D and FIG. 16E described previously.

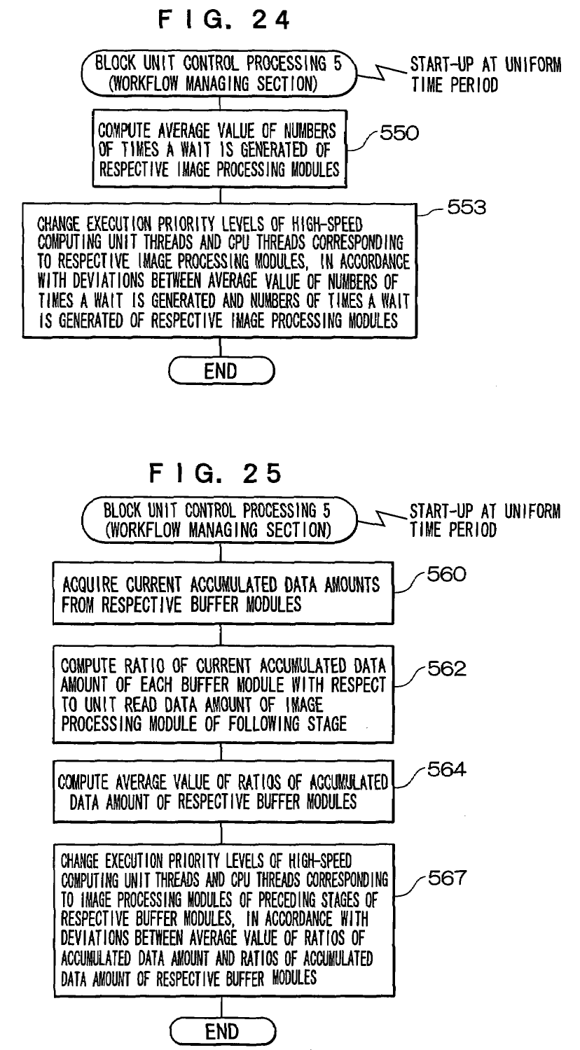

Moreover, in the fourth exemplary embodiment, the execution priority levels of the high-speed computing unit threads and the CPU threads corresponding to the individual image processing modules are changed in accordance with the extent of progress of the image processing of the image processing section overall, but the present invention is not limited to the same. In the same way as in the second exemplary embodiment, in the block unit control processing 5 (see FIG. 24) that is executed at a uniform time period, the execution priority levels of the high-speed computing unit threads and the CPU threads corresponding to the individual image processing modules 38 may be changed (refer to step 553 in FIG. 24) in accordance with the numbers of times a wait is generated of the individual image processing modules 38 (the number of times that a “wait” is generated at the image processing module 38 of the following stage which is connected via the buffer module 40 of the following stage; this number of times corresponds to the number of times acquisition has failed of the present invention). Note that this aspect corresponds to the present invention, and in this aspect, the (CPU 12 which executes the programs of the) workflow managing section 46A functions also as the priority level controlling component of the present invention.

In more detail, the changing of the execution priority levels of the high-speed computing unit threads and the CPU threads in this aspect can be carried out such that, for the image processing module 38 whose number of times a wait is generated is higher than the average value computed in step 550 (see FIG. 24), the greater the deviation between the average value and the number of times a wait is generated, the more the execution priority level of the corresponding high-speed computing unit thread is increased and the more the execution priority level of the corresponding CPU thread is lowered, whereas for the image processing module 38 whose number of times a wait is generated is lower than the average value, the greater the deviation between the average value and the number of times a wait is generated, the more the execution priority level of the corresponding CPU thread is increased and the more the execution priority level of the corresponding high-speed computing unit thread is lowered. In this case as well, the high-speed computing unit 12A (and the CPU 12) are utilized effectively, and image processing can be carried out at a high processing efficiency.

Instead of changing the execution priority levels of the high-speed computing unit threads and the CPU threads corresponding to the individual image processing modules in accordance with the extent of progress of the image processing of the image processing section overall, in the same way as in the third exemplary embodiment, in the block unit control processing 5 (see FIG. 25) which is executed at a uniform time period, the execution priority levels of the high-speed computing unit threads and the CPU threads corresponding to the respective image processing modules 38 of the preceding stages of the individual buffer modules 40 may be changed (see step 567 of FIG. 25) in accordance with the deviations between the average value of the ratios of the accumulated data amount of the individual buffer modules 40 and the ratios of the accumulated data amount of the individual buffer modules 40. This aspect corresponds to the present invention, and in this aspect, the (CPU 12 which executes the programs of the) workflow managing section 46A functions also as the priority level controlling component of the present invention.

In more detail, the changing of the execution priority levels of the high-speed computing unit threads and the CPU threads in this aspect can be carried out such that, for the image processing module 38 of the preceding stage of the buffer module 40 whose ratio of the accumulated data amount is higher than the average value of the ratios of the accumulated data amount computed in step 564 (see FIG. 25), the greater the deviation between the average value and the ratio of the accumulated data amount, the more the execution priority level of the corresponding high-speed computing unit thread is increased and the more the execution priority level of the corresponding CPU thread is decreased, whereas for the image processing module 38 of the preceding stage of the buffer module 40 whose ratio of the accumulated data amount is lower than the average value, the greater the deviation between the average value and the ratio of the accumulated data amount, the more the execution priority level of the corresponding CPU thread is increased and the more the execution priority level of the corresponding high-speed computing unit thread is decreased. In this case as well, the high-speed computing unit 12A (and the CPU 12) are utilized effectively, and image processing can be carried out at a high processing efficiency.

As described above, in the aspect in which the execution priority levels of the high-speed computing unit threads and the CPU threads corresponding to the image processing modules 38 are changed in accordance with the numbers of times a wait is generated of the individual image processing modules 38 (the aspect of FIG. 24), and in the aspect in which the execution priority levels of the high-speed computing unit threads and the CPU threads corresponding to the image processing modules 38 of the preceding stages are changed in accordance with the ratios of the accumulated data amount of the buffer modules 40 (the aspect of FIG. 25), the execution priority levels of the high-speed computing unit threads and the CPU threads corresponding to the individual image processing modules 38 are optimized by the block unit control processing 5 (FIG. 24 or FIG. 25) being repeatedly carried out. Therefore, as described in the second and third exemplary embodiments as well, the initial setting of the execution priority levels of the high-speed computing unit threads and the CPU threads corresponding to the individual image processing modules 38 (step 503 of FIGS. 22A through 22D) can be omitted.

Description has been given of structures in which, in the first through third exemplary embodiments, only the one CPU 12 is provided as the program executing resource, and, in the fourth exemplary embodiment, one of each of the CPU 12 and the high-speed computing unit 12A are provided as the program executing resources. However, the present invention is not limited to the same, and can be applied as well to a structure in which a plurality of the same type of program executing resource are provided.

In this aspect, in a case in which the image processing progresses at the image processing section and the number of the image processing modules 38 at which image processing is not completed becomes less than or equal to the total number of the CPUs 12 (i.e., a case in which only the programs for execution at the CPU are readied as the programs corresponding to the individual image processing modules 38), or in a case in which the number of the image processing modules 38 at which image processing is not completed becomes less than or equal to the total number of program executing resources (e.g., the total value of the number of the CPUs 12 and the number of the high-speed computing units 12A) (i.e., a case in which the programs for execution at the CPU and the programs for execution at the high-speed computing unit are readied as the programs corresponding to the individual image processing modules 38), the individual threads corresponding to the individual image processing modules at which image processing is not completed enter into states in which they can occupy respectively different program executing resources, and there is no struggle among the threads corresponding to the individual image processing modules for the program executing resources. Therefore, in the above-described cases, the processing of changing the execution priority levels of the respective threads corresponding to the individual image processing modules 38 may be ended. In this way, the processing of changing the execution priority levels of the threads in the time period thereafter can be prevented from being overhead in the image processing at the image processing section, and the processing efficiency of the image processing can be improved even more.

The above describes an aspect in which the changing of the execution priority levels of the threads corresponding to the individual image processing modules 38 is carried out at the workflow managing section 46A, but the present invention is not limited to the same. The threads corresponding to the individual image processing modules 38 may carry out the changing of the execution priority levels of the threads themselves (the programs themselves). In such an aspect, if the execution priority levels are changed in accordance with the numbers of times a wait is generated of the image processing modules 38 or the ratios of the accumulated data amount of the buffer modules 40, a structure in which the computing of the average value (or the median) of the numbers of times a wait is generated or the ratios of the accumulated data amount is carried out collectively at the workflow managing section 46A or a processing section similar thereto, and the individual threads refer to the results of computation of the average value (or the median) of the numbers of times a wait is generated or the ratios of the accumulated data amount and judge and change the execution priority levels of the threads themselves (the programs themselves), is preferable because the processing efficiency of the image processing can be improved. Further, the changing of the execution priority levels of the threads can be carried out by, for example, setting different execution priority levels at the times when the threads are deleted and regenerated and the program executing resources are allocated.

The above describes an aspect in which the execution priority levels are changed for only the threads which correspond to the image processing modules 38, but the present invention is not limited to the same. For example, in the buffer control processing executed by the buffer control section 40B of the buffer module 40, if the data writing processing (FIGS. 7A and 7B) and the data reading processing (FIGS. 9A and 9B) are structured so as to be executed as separate threads, the execution priority levels of the threads corresponding to the buffer control sections 40B of the individual buffer modules 40 can be changed in addition thereto such that, for example, the execution priority levels of the threads corresponding to the data writing processing are changed linkingly with the execution priority levels of the threads corresponding to the image processing modules 38 of the preceding stages of the buffer modules 40 (or the ratios of the execution priority levels of the high-speed computing unit threads with respect to the execution priority levels of the CPU threads), and the execution priority levels of the threads corresponding to the data reading processing are changed linkingly with the execution priority levels of the threads corresponding to the image processing modules 38 of the following stages of the buffer modules 40 (or the ratios of the execution priority levels of the high-speed computing unit threads with respect to the execution priority levels of the CPU threads), or the like.

Description is given above of an example in which, although a reading request is inputted to the buffer module 40 from the image processing module 38 of the following stage, in a case in which the data amount of the effective data, which can be read by the image processing module 38 which is the source of the reading request, is less than the unit read data amount, and the end of the effective data which can be read is not the end of the image data which is the object of processing, a data request is repeatedly inputted from the buffer module 40 to the workflow managing section 46A until either the data amount of the effective data which can be read becomes greater than or equal to the unit read data amount, or it is sensed that the end of the effective data which can be read is the end of the image data which is the object of processing. However, the present invention is not limited to the same. In the above-described case, the buffer module 40 may input a data request to the workflow managing section 46A only one time, and may input an accumulation completed notice to the workflow managing section 46A either when the data amount of the effective data which can be read becomes greater than or equal to the unit read data amount, or when it is sensed that the end of the effective data which can be read is the end of the image data which is the object of processing. Then, during the period of time from after the data request has been inputted from the buffer module 40 until the accumulation completed notice is inputted, the workflow managing section 46A may repeatedly input a processing request to the image processing module 38 of the preceding stage of that buffer module 40.

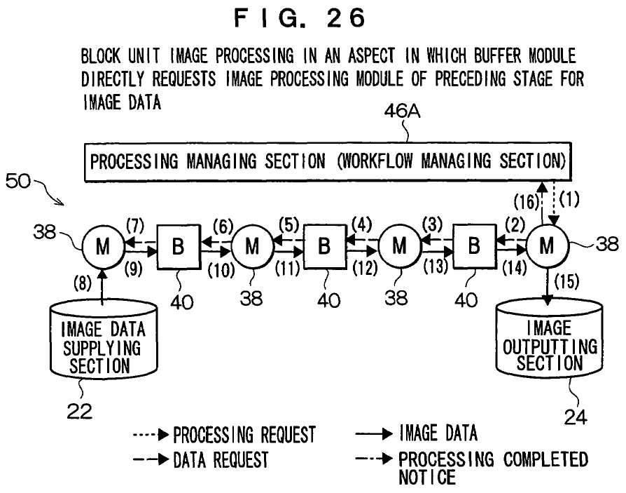

Further, the above describes, as an example, an aspect in which, at the buffer module 40, in a case in which a reading request is inputted from the image processing module 38 of the following stage and effective data, which can be read by the image processing module 38 which is the source of the reading request, is not stored in the buffer 40A of its own module, the buffer control section 40B inputs a data request to the workflow managing section 46A. However, the present invention is not limited to the same, and in the above-described case, the buffer control section 40B may directly input a data request to the image processing module 38 of the preceding stage. The processing sequence in this aspect is shown in FIG. 26. As is clear from FIG. 26 as well, in this aspect, it suffices for the workflow managing section 46A to input a processing request only to the image processing module 38 of the final stage in the image processing section 50, and therefore, the processing at the workflow managing section 46A is simple.

Further, as an example of image processing of a block unit, an aspect is described above in which, first, the workflow managing section 46A inputs a processing request to the image processing module 38 of the final stage of the image processing section 50, and that processing request is successively transferred to modules of the preceding stages as a data request or a processing request. However, the present invention is not limited to the same. It is also possible to successively transfer the processing request or data request from the modules of the preceding stages to the modules of the following stages, and carry out image processing in block units. This can be realized as follows for example. The buffer control section 40B of the buffer module 40 is structured such that, each time image data is written to the buffer 40A by the image processing module 38 of the preceding stage of its own module, if the data amount of the effective data which can be read by the image processing module 38 of the following stage is less than the unit read data amount and the end of the effective data which can be read is not the end of the image data which is the object of processing, the buffer control section 40B inputs the data request to the workflow managing section 46A, whereas, on the other hand, the buffer control section 40B inputs the accumulation completed notice to the workflow managing section 46A either when the data amount of the effective data which can be read becomes greater than or equal to the unit read data amount, or when it is sensed that the end of the effective data which can be read is the end of the image data which is the object of processing. Moreover, the workflow managing section 46A is structured such that, after inputting a processing request to the image processing module 38 of the final stage of the image processing section 50, each time a data request is inputted from an arbitrary buffer module 40, the workflow managing section 46A inputs a processing request to the image processing module 38 of the preceding stage of the buffer module 40 which is the source of the data request, and each time an accumulation completed notice is inputted from an arbitrary buffer module 40, the workflow managing section 46A inputs a processing request to the image processing module 38 of the following stage of that buffer module 40. Further, in the above, it is possible for the data request from the buffer module 40 to be directly inputted as a processing request to the image processing module 38 of the preceding stage of that buffer module 40, and for the accumulation completed notice from the buffer module 40 to be directly inputted as a processing request to the image processing module 38 of the following stage of that buffer module 40.

Moreover, the above describes an aspect in which, for the buffer module 40, the unit write data amount is set in advance from the image processing module 38 of the preceding stage, and the unit read data amount is set in advance from the image processing module of the following stage. However, the present invention is not limited to the same. The data amount of writing or reading may be notified from the image processing module 38 each time of writing data to the buffer module 40 or reading data from the buffer module 40.

In the above description, each time a writing request or a reading request is inputted to the buffer module 40, the inputted request is registered in a queue as request information, and the request information is taken-out one-by-one from the queue and processed. In this way, exclusive control is realized in which, at the time of input of a writing request, if reading of data from the buffer 40A is being executed, after that data reading is completed, data writing processing corresponding to that writing request is carried out, and, at the time of input of a reading request, if writing of data to the buffer 40A is being executed, after that data writing is completed, data reading processing corresponding to that reading request is carried out. However, the present invention is not limited to the same. For example, exclusive control which uses a unit buffer region as a unit may be carried out. Namely, at the time of input of a writing request, if reading of data is being executed with respect to a unit buffer region which is the object of writing in that writing request within the buffer 40A, after that data reading is completed, data writing processing corresponding to that writing request is carried out. Further, at the time of input of a reading request, if writing of data is being executed with respect to a unit buffer region which is the object of reading in that reading request within the buffer 40A, after that data writing is completed, data reading processing corresponding to that reading request is carried out. Exclusive control which uses a unit buffer region as a unit can be realized by, for example, providing a queue at each individual unit buffer region and carrying out exclusive control, or by utilizing a technique such as the aforementioned mutex or the like, or the like.

Further, the above describes an example in which, among the individual image processing modules 38 whose programs are registered in the module library 36, programs, which correspond to the control sections 38B of the image processing modules 38 whose unit read data amounts and unit write data amounts are the same, are used in common. However, the present invention is not limited to the same. For example, the program corresponding to the control section 388B may be divided into a program which corresponds to a first control section which acquires image data from the module of the preceding stage and inputs it to the image processing engine 38A, a program which corresponds to a second control section which outputs to the module of the preceding stage data which is outputted from the image processing engine 38A, and a program which corresponds to a common control section which carries out control (e.g., communication with the workflow managing section 46A, or the like) which does not depend on the unit read data amount, the unit processing data amount, or the unit write data amount. At all of the image processing modules, the program corresponding to the common control section is used in common. The program corresponding to the first control section is used in common at the image processing modules 38 whose unit read data amounts are the same. The program corresponding to the second control section is used in common at the image processing modules 38 whose unit write data amounts are the same.

Because the individual modules themselves which structure the image processing section 50 are programs, the image processing by the image processing section 50 are realized by the CPU 12 in actuality. Here, the following system may be used: the programs corresponding to the individual image processing modules 38 structuring the image processing section 50 are registered in a queue as threads (or processes or objects) which are objects of execution by the CPU 12. Each time a program, which is registered in that queue and which corresponds to a specific image processing module, is taken-out from the queue by the CPU 12, it is judged whether or not image data of the unit processing data amount can be acquired from the module of the preceding stage of the specific image processing module 38. Only in cases in which is judged that the image data of the unit processing data amount can be acquired, the image data of the unit processing data amount is acquired from the module of the preceding stage of the specific image processing module 38. Predetermined image processing (processing corresponding to the image processing engine 38A of the specific image processing module 38) is carried out on the acquired image data of the unit processing data amount. Processing is carried out which outputs, to the module of the following stage of its own module, the image data which has undergone the predetermined image processing, or the processing results of the predetermined image processing. Thereafter, if processing on the entire image which is the object of processing is not finished, the taken-out program corresponding to the specific image processing module is re-registered in the queue as a thread (or a process or an object) of the object of execution. Due to the CPU 12 repeating these unit image processing, the entire image which is the object of processing is processed by the image processing section 50 (round robin system).

Moreover, an aspect is described above in which the workflow managing section 46A carries out control such that the image processing section on the whole carries out block unit processing by causing the individual image processing modules 38 of the image processing section to operate so as to carry out image processing in parallel while transferring image data to the following stage in units of a data amount which is smaller than one surface of the image. However, the present invention is not limited to the same. The workflow managing section 46A may be structured such that the image processing section on the whole can also carry out surface unit processing by causing the individual image processing modules 38 of the image processing section to operate such that, after the image processing module 38 of the preceding stage completes image processing on image data of one surface of the image, the image processing module 38 of the following stage carries out image processing on image data of one surface of the image.

What is claimed is:

1. An image processing device comprising:
an image processing section constructed by individual modules being connected in a pipeline form or a directed acyclic graph form, such that a buffer module is connected with at least one of a preceding stage and a following stage of individual image processing modules, the image processing section having;
each of the plurality of image processing modules has functions of acquiring image data in units of a unit data amount from a preceding stage of the image processing module, and carrying out a predetermined image processing on acquired image data, and outputting image data which has undergone the predetermined image processing or processing results of the predetermined image processing to a following stage of the image processing module, the plurality of image processing modules being selected from plural types of image processing modules whose types or contents of executed image processing are respectively different,
the buffer module has a buffer, and in a case in which an image processing module is connected at a preceding stage of the buffer module, the buffer module causes writing of image data, which is outputted from the image processing module of the preceding stage, to the buffer, and in a case in which an image processing module is connected at a following stage of the buffer module, the buffer module causes the image processing module of the following stage to read image data which is stored in the buffer,
the individual image processing modules are realized by corresponding programs being executed in parallel by a program executing resource provided at the image processing device, and
the image processing device further comprises a priority level controlling component which carries out initial setting of execution priority levels of the programs of the individual image processing modules, and changing of the execution priority levels in accordance with extents of progress of image processing.

2. The image processing device of claim 1, wherein a plurality of the program executing resources are provided at the image processing device, and the programs of the individual image processing modules are executed in parallel by the plurality of the program executing resources, and
the priority level controlling component ends changing of the execution priority levels when a number of image processing modules at which image processing is not completed becomes less than or equal to a number of the program executing resources provided at the image processing device.

3. An image processing device comprising:
an image processing section constructed by individual modules being connected in a pipeline form or a directed acyclic graph form, such that a buffer module exists respectively at least between individual image processing modules, the image processing section having;
each of the plurality of image processing modules has functions of repeatedly attempting acquisition of image data of a unit data amount from a preceding stage of the image processing module, and stopping execution of image processing while failing to acquire image data, and carrying out a predetermined image processing on acquired image data when succeeding in acquiring image data, and outputting image data which has undergone the predetermined image processing or processing results of the predetermined image processing to a following stage of the image processing module, the plurality of image processing modules being selected from plural types of image processing modules whose types or contents of executed image processing are respectively different,
the buffer module has a buffer, and in a case in which an image processing module is connected at a preceding stage of the buffer module, the buffer module causes writing of image data, which is outputted from the image processing module of the preceding stage, to the buffer, and in a case in which an image processing module is connected at a following stage of the buffer module, the buffer module causes the image processing module of the following stage to read image data which is stored in the buffer,
the individual image processing modules are realized by corresponding programs being executed in parallel by a program executing resource provided at the image processing device, and
the image processing device further comprises a priority level controlling component which changes execution priority levels of the programs of the individual image processing modules, in accordance with numbers of times image data acquisition has failed at the individual image processing modules.

4. The image processing device of claim 3, wherein the priority level controlling component also carries out initial setting of the execution priority levels of the programs of the individual image processing modules.

5. The image processing device of claim 3, wherein a plurality of the program executing resources are provided at the image processing device, and the programs of the individual image processing modules are executed in parallel by the plurality of the program executing resources, and
the priority level controlling component ends changing of the execution priority levels when a number of image processing modules at which image processing is not completed becomes less than or equal to a number of the program executing resources provided at the image processing device.

6. An image processing device comprising:
an image processing section constructed by individual modules being connected in a pipeline form or a directed acyclic graph form, such that a buffer module is connected with at least one of a preceding stage and a following stage of individual image processing modules, the image processing section having;
each of the plurality of image processing modules has functions of acquiring image data in units of a unit data amount from a preceding stage of its own module, and carrying out a predetermined image processing on acquired image data, and outputting image data which has undergone the predetermined image processing or processing results of the predetermined image processing to a following stage of the image processing module, the plurality of image processing modules being selected from plural types of image processing modules whose types or contents of executed image processing are respectively different,
the buffer module has a buffer, and in a case in which an image processing module is connected at a preceding stage of the buffer module, the buffer module causes writing of image data, which is outputted from the image processing module of the preceding stage, to the buffer, and in a case in which an image processing module is connected at a following stage of the buffer module, the buffer module causes the image processing module of the following stage to read image data which is stored in the buffer,
the individual image processing modules are realized by corresponding programs being executed in parallel by a program executing resource provided at the image processing device, and
the image processing device further comprises a priority level controlling component which changes execution priority levels of the programs of the individual image processing modules, in accordance with ratios of data amounts of image data stored in individual buffer modules, with respect to unit data amounts at times when image processing modules of the following stages of the individual buffer modules acquire image data from the individual buffer modules.

7. The image processing device of claim 6, wherein the priority level controlling component also carries out initial setting of the execution priority levels of the programs of the individual image processing modules.

8. The image processing device of claim 6, wherein a plurality of the program executing resources are provided at the image processing device, and the programs of the individual image processing modules are executed in parallel by the plurality of the program executing resources, and
the priority level controlling component ends changing of the execution priority levels when a number of image processing modules at which image processing is not completed becomes less than or equal to a number of the program executing resources provided at the image processing device.

9. An image processing device comprising:
an image processing section constructed by individual modules being connected in a pipeline form or a directed acyclic graph form, such that a buffer module is connected with at least one of a preceding stage and a following stage of individual image processing modules, the image processing section having;
each of the plurality of image processing modules has functions of acquiring image data in units of a unit data amount from a preceding stage of the image processing module, and carrying out a predetermined image processing on acquired image data, and outputting image data which has undergone the predetermined image processing or processing results of the predetermined image processing to a following stage of the image processing module, the plurality of image processing modules being selected from plural types of image processing modules whose types or contents of executed image processing are respectively different,
the buffer module has a buffer, and in a case in which an image processing module is connected at a preceding stage of the buffer module, the buffer module causes writing of image data, which is outputted from the image processing module of the preceding stage, to the buffer, and in a case in which an image processing module is connected at a following stage of the buffer module, the buffer module causes the image processing module of the following stage to read image data which is stored in the buffer,
the individual image processing modules are realized by corresponding programs being executed in parallel by a program executing resource provided at the image processing device,
a first program that is executed by a CPU provided at the image processing device, and a second program that is executed by a high-speed computing unit provided at the image processing device, are respectively provided at each image processing module as corresponding programs, and the individual image processing modules are realized by execution of the first program by the CPU and execution of the second program by the high-speed computing unit being carried out exclusively, and
the image processing device further comprises a priority level controlling component which carries out initial setting of execution priority levels of the first programs and the second programs of the individual image processing modules, and changing of the execution priority levels in accordance with extents of progress of image processing.

10. An image processing device comprising:
an image processing section constructed by individual modules being connected in a pipeline form or a directed acyclic graph form, such that a buffer module exists respectively at least between individual image processing modules, the image processing section having;
each of the plurality of image processing modules has functions of repeatedly attempting acquisition of image data of a unit data amount from a preceding stage of the image processing module, and stopping execution of image processing while failing to acquire image data, and carrying out a predetermined image processing on acquired image data when succeeding in acquiring image data, and outputting image data which has undergone the predetermined image processing or processing results of the predetermined image processing to a following stage of the image processing module, the plurality of image processing modules being selected from among plural types of image processing modules whose types or contents of executed image processing are respectively different,
the buffer module has a buffer, and in a case in which an image processing module is connected at a preceding stage of the buffer module, the buffer module causes writing of image data, which is outputted from the image processing module of the preceding stage, to the buffer, and in a case in which an image processing module is connected at a following stage of the buffer module, the buffer module causes the image processing module of the following stage to read image data which is stored in the buffer,
a first program that is executed by a CPU provided at the image processing device, and a second program that is executed by a high-speed computing unit provided at the image processing device, are respectively provided at each image processing module as corresponding programs, and the individual image processing modules are realized by execution of the first program by the CPU and execution of the second program by the high-speed computing unit being carried out exclusively, and
the image processing device further comprises a priority level controlling component which changes execution priority levels of the first programs and the second programs of the individual image processing modules, in accordance with numbers of times image data acquisition has failed at the individual image processing modules.

11. The image processing device of claim 10, wherein the priority level controlling component also carries out initial setting of the execution priority levels of the first programs and the second programs of the individual image processing modules.

12. An image processing device comprising:
an image processing section constructed by individual modules being connected in a pipeline form or a directed acyclic graph form, such that a buffer module is connected with at least one of a preceding stage and a following stage of individual image processing modules, the image processing section having;
each of the plurality of image processing modules has functions of acquiring image data in units of a unit data amount from a preceding stage of the image processing module, and carrying out a predetermined image processing on acquired image data, and outputting image data which has undergone the predetermined image processing or processing results of the predetermined image processing to a following stage of the image processing module, the plurality of image processing modules being selected from plural types of image processing modules whose types or contents of executed image processing are respectively different,
the buffer module has a buffer, and in a case in which an image processing module is connected at a preceding stage of the buffer module, the buffer module causes writing of image data, which is outputted from the image processing module of the preceding stage, to the buffer, and in a case in which an image processing module is connected at a following stage of the buffer module, the buffer module causes the image processing module of the following stage to read image data which is stored in the buffer,
a first program that is executed by a CPU provided at the image processing device, and a second program that is executed by a high-speed computing unit provided at the image processing device, are respectively provided at each image processing module as corresponding programs, and the individual image processing modules are realized by execution of the first program by the CPU and execution of the second program by the high-speed computing unit being carried out exclusively, and
the image processing device further comprises a priority level controlling component which changes execution priority levels of the first programs and the second programs of the individual image processing modules, in accordance with ratios of data amounts of image data stored in individual buffer modules, with respect to unit data amounts at times when image processing modules of the following stages of the individual buffer modules acquire image data from the individual buffer modules.

13. The image processing device of claim 12, wherein the priority level controlling component also carries out initial setting of the execution priority levels of the first programs and the second programs of the individual image processing modules.

14. A computer readable medium storing an image processing program for causing a computer to function as an image processing device having an image processing section constructed by individual modules being connected in a pipeline form or a directed acyclic graph form, such that a buffer module is connected with at least one of a preceding stage and a following stage of individual image processing modules, wherein each of the plurality of image processing modules has functions of acquiring image data in units of a unit data amount from a preceding stage of the image processing module, and carrying out a predetermined image processing on acquired image data, and outputting image data which has undergone the predetermined image processing or processing results of the predetermined image processing to a following stage of the image processing module, the plurality of image processing modules being selected from plural types of image processing modules whose types or contents of executed image processing are respectively different,
the buffer module has a buffer, and in a case in which an image processing module is connected at a preceding stage of the buffer module, the buffer module causes writing of image data, which is outputted from the image processing module of the preceding stage, to the buffer, and in a case in which an image processing module is connected at a following stage of the buffer module, the buffer module causes the image processing module of the following stage to read image data which is stored in the buffer,
the individual image processing modules are realized by corresponding programs being executed in parallel by a program executing resource provided at the image processing device, and
the image processing program causes the computer to further function as a priority level controlling component which carries out initial setting of execution priority levels of the programs of the individual image processing modules, and changing of the execution priority levels in accordance with extents of progress of image processing.

15. A computer readable medium storing an image processing program for causing a computer to function as an image processing device having an image processing section constructed by individual modules being connected in a pipeline form or a directed acyclic graph form, such that a buffer module exists respectively at least between individual image processing modules, wherein
each of the plurality of image processing modules has functions of repeatedly attempting acquisition of image data of a unit data amount from a preceding stage of the image processing module, and stopping execution of image processing while failing to acquire image data, and carrying out a predetermined image processing on acquired image data when succeeding in acquiring image data, and outputting image data which has undergone the predetermined image processing or processing results of the predetermined image processing to a following stage of the image processing module, the plurality of image processing modules being selected from plural types of image processing modules whose types or contents of executed image processing are respectively different,
the buffer module has a buffer, and in a case in which an image processing module is connected at a preceding stage of the buffer module, the buffer module causes writing of image data, which is outputted from the image processing module of the preceding stage, to the buffer, and in a case in which an image processing module is connected at a following stage of the buffer module, the buffer module causes the image processing module of the following stage to read image data which is stored in the buffer,
the individual image processing modules are realized by corresponding programs being executed in parallel by a program executing resource provided at the image processing device, and
the image processing program causes the computer to further function as a priority level controlling component which changes execution priority levels of the programs of the individual image processing modules, in accordance with numbers of times image data acquisition has failed at the individual image processing modules.

16. A computer readable medium storing an image processing program for causing a computer to function as an image processing device having an image processing section constructed by individual modules being connected in a pipeline form or a directed acyclic graph form, such that a buffer module is connected with at least one of a preceding stage and a following stage of individual image processing modules, wherein
each of the plurality of image processing modules has functions of acquiring image data in units of a unit data amount from a preceding stage of the image processing module, and carrying out a predetermined image processing on acquired image data, and outputting image data which has undergone the predetermined image processing or processing results of the predetermined image processing to a following stage of the image processing module, the plurality of image processing modules being selected from plural types of image processing modules whose types or contents of executed image processing are respectively different,
the buffer module has a buffer, and in a case in which an image processing module is connected at a preceding stage of the buffer module, the buffer module causes writing of image data, which is outputted from the image processing module of the preceding stage, to the buffer, and in a case in which an image processing module is connected at a following stage of the buffer module, the buffer module causes the image processing module of the following stage to read image data which is stored in the buffer,
the individual image processing modules are realized by corresponding programs being executed in parallel by a program executing resource provided at the image processing device, and
the image processing program causes the computer to further function as a priority level controlling component which changes execution priority levels of the programs of the individual image processing modules, in accordance with ratios of data amounts of image data stored in individual buffer modules, with respect to unit data amounts at times when image processing modules of the following stages of the individual buffer modules acquire image data from the individual buffer modules.

17. A computer readable medium storing an image processing program for causing a computer to function as an image processing device having an image processing section constructed by individual modules being connected in a pipeline form or a directed acyclic graph form, such that a buffer module is connected with at least one of a preceding stage and a following stage of individual image processing modules, wherein
each of the plurality of image processing modules has functions of acquiring image data in units of a unit data amount from a preceding stage of the image processing module, and carrying out a predetermined image processing on acquired image data, and outputting image data which has undergone the predetermined image processing or processing results of the predetermined image processing to a following stage of the image processing module, the plurality of image processing modules being selected from plural types of image processing modules whose types or contents of executed image processing are respectively different,
the buffer module has a buffer, and in a case in which an image processing module is connected at a preceding stage of the buffer module, the buffer module causes writing of image data, which is outputted from the image processing module of the preceding stage, to the buffer, and in a case in which an image processing module is connected at a following stage of the buffer module, the buffer module causes the image processing module of the following stage to read image data which is stored in the buffer,
the individual image processing modules are realized by corresponding programs being executed in parallel by a program executing resource provided at the image processing device,
a first program that is executed by a CPU provided at the image processing device, and a second program that is executed by a high-speed computing unit provided at the image processing device, are respectively provided at each image processing module as corresponding programs, and the individual image processing modules are realized by execution of the first program by the CPU and execution of the second program by the high-speed computing unit being carried out exclusively, and
the image processing program causes the computer to further function as a priority level controlling component which carries out initial setting of execution priority levels of the first programs and the second programs of the individual image processing modules, and changing of the execution priority levels in accordance with extents of progress of image processing.

18. A computer readable medium storing an image processing program for causing a computer to function as an image processing device having an image processing section constructed by individual modules being connected in a pipeline form or a directed acyclic graph form, such that a buffer module exists respectively at least between individual image processing modules, wherein
each of the plurality of image processing modules has functions of repeatedly attempting acquisition of image data of a unit data amount from a preceding stage of the image processing module, and stopping execution of image processing while failing to acquire image data, and carrying out a predetermined image processing on acquired image data when succeeding in acquiring image data, and outputting image data which has undergone the predetermined image processing or processing results of the predetermined image processing to a following stage of the image processing module, the plurality of image processing modules being selected from plural types of image processing modules whose types or contents of executed image processing are respectively different,
the buffer module has a buffer, and in a case in which an image processing module is connected at a preceding stage of the buffer module, the buffer module causes writing of image data, which is outputted from the image processing module of the preceding stage, to the buffer, and in a case in which an image processing module is connected at a following stage of the buffer module, the buffer module causes the image processing module of the following stage to read image data which is stored in the buffer,
a first program that is executed by a CPU provided at the image processing device, and a second program that is executed by a high-speed computing unit provided at the image processing device, are respectively provided at each image processing module as corresponding programs, and the individual image processing modules are realized by execution of the first program by the CPU and execution of the second program by the high-speed computing unit being carried out exclusively, and
the image processing program causes the computer to further function as a priority level controlling component which changes execution priority levels of the first programs and the second programs of the individual image processing modules, in accordance with numbers of times image data acquisition has failed at the individual image processing modules.

19. A computer readable medium storing an image processing program for causing a computer to function as an image processing device having an image processing section constructed by individual modules being connected in a pipeline form or a directed acyclic graph form, such that a buffer module is connected with at least one of a preceding stage and a following stage of individual image processing modules, wherein each of the plurality of image processing modules has functions of acquiring image data in units of a unit data amount from a preceding stage of the image processing module,
and carrying out a predetermined image processing on acquired image data, and outputting image data which has undergone the predetermined image processing or processing results of the predetermined image processing to a following stage of the image processing module, the plurality of image processing modules being selected from plural types of image processing modules whose types or contents of executed image processing are respectively different,
the buffer module has a buffer, and in a case in which an image processing module is connected at a preceding stage of the buffer module, the buffer module causes writing of image data, which is outputted from the image processing module of the preceding stage, to the buffer, and in a case in which an image processing module is connected at a following stage of the buffer module, the buffer module causes the image processing module of the following stage to read image data which is stored in the buffer,
a first program that is executed by a CPU provided at the image processing device, and a second program that is executed by a high-speed computing unit provided at the image processing device, are respectively provided at each image processing module as corresponding programs, and the individual image processing modules are realized by execution of the first program by the CPU and execution of the second program by the high-speed computing unit being carried out exclusively, and
the image processing program causes the computer to further function as a priority level controlling component which changes execution priority levels of the first programs and the second programs of the individual image processing modules, in accordance with ratios of data amounts of image data stored in individual buffer modules, with respect to unit data amounts at times when image processing modules of the following stages of the individual buffer modules acquire image data from the individual buffer modules.
